(19) United States
(12) Patent Application Publication
(10) Pub. No.: US 2026/0326578 A1
(43) Pub. Date: Oct. 22, 2026

(54) PLANNED ELECTRIC POWER GENERATION AND STORAGE CONTROL TECHNOLOGY USING SOC CHART

(71) Applicant: EXEDY Corporation, Osaka (JP)

(72) Inventors: Shoichi SHIMIZU, Yokohama city, Kanagawa (JP); Shigeru YOSHIMOCHI, Yamagata city, Yamagata (JP); Hideo MORI, Yokohama city, Kanagawa (JP)

(21) Appl. No.: 19/122,789

(22) PCT Filed: Oct. 21, 2022
(86) PCT No.: PCT/JP2022/039393

§ 371 Date: Apr. 21, 2025

(51) Int. Cl. B60L 50/61; B60L 58/13

(52) U.S. Cl. CPC B60L 50/61; B60L 58/13; B60L 2200/18; B60L 2200/36; B60L 2260/52; B60L 2260/54; B60L 2270/12

(57) ABSTRACT

One embodiment of the present invention has been made to solve the problem, and provides, as a method of estimating an electric power generation amount and an electric power generation section required during traveling in a traveling plan of the range extended EV before traveling, a planned electric power generation and storage control technology capable of downsizing a secondary battery and a generator to be mounted by assuming that the vehicle travels from a departure point to a destination point only with electric power of the battery, setting, as the electric power generation amount required during traveling, an absolute value of a value obtained by subtracting a required minimum electric power storage amount (SCL) of the battery from a negative electric power storage amount (SOC value) of the battery at the destination point, and correcting the traveling plan during, preferably, traveling.

### TECHNICAL FIELD

The present invention relates to a planned electric power generation and storage control method for a plug-in range extended-electrical vehicle (EV) that travels by charging a secondary battery using an engine generator and driving a motor using the secondary battery.

### BACKGROUND ART

An EV vehicle driven by a secondary battery is attracting attention as a clean transportation system that does not emit carbon dioxide (CO₂). The first reason is that, unlike a vehicle that travels using an internal combustion engine, an EV vehicle travels by driving a motor using electric power stored in the secondary battery, so that there is no CO₂ emission, the EV vehicle is quiet, and ride comfort is excellent. The second reason is that a maintenance cost including a fuel cost is cheaper than the cost in a vehicle using a diesel engine and the like, so that an advantage of introduction is considered to be large.

However, a current initial investment cost of an EV bus, which is a type of an EV vehicle, is several times higher than the cost of a diesel-engine bus with the same number of seats because the EV bus requires a large number of expensive secondary batteries to be mounted. As a result, introduction of the EV bus has not progressed. Further, in an EV truck, the spread of the EV truck is delayed due to poor usability, for example, a space for a large number of secondary batteries reduces a loading amount of the truck.

As a solution to these problems, a series hybrid system is applied to a passenger car. In general, in this technology, an existing engine is used as a generator, a small-capacity secondary battery is mounted, the engine is almost always driven to charge the secondary battery, and a motor is driven by electric power of the secondary battery. Thus, the vehicle is moved.

However, in a case of application to a commercial vehicle such as a bus or a truck, when a state of charge of the secondary battery is low and electric power generation is performed, it is required to supply a large amount of instantaneous electric power in order to travel on a steep long uphill, and as a result, a large generator and a large number of secondary batteries are required. As a result, space is taken up, the number of seats is reduced in a bus, and a cargo loading amount is limited in a truck. Thus, series hybridization of commercial vehicles has hardly progressed.

On the other hand, a range extended EV (hereinafter, referred to as a RE-EV) vehicle according to the present technology collects position information on a traveling route and road surface information such as an altitude difference by utilizing a geographic information system (GIS) and a global navigation satellite system (GNSS; global positioning satellite system), and further creates an electric power generation plan (traveling plan) before traveling by using traveling data accumulated during traveling so far. In addition, in a case where a charger is set on a traveling route, a plug-in range extended EV (hereinafter, referred to as PRE-EV) vehicle that creates a traveling plan incorporating charging (plug-in) at the charger can be used.

By creating a traveling plan for the day before traveling in this way, a required electric power generation amount can be calculated in advance, and thus, an appropriate start timing of electric power generation and an appropriate period of electric power generation during traveling can be set. Thereby, it is possible to downsize the generator and the secondary batteries.

The proposer has previously made a patent proposal in which such a RE-EV technology is applied to a bus which is one of main vehicles of a public transportation system (JP 2019-77257 A). Further, a patent proposal has been made for a method of configuring a PRE-EV vehicle intended for a commercial vehicle such as a large truck equipped with a planned electric power generation and storage control technology (JP 2020-62906 A).

As prior art similar to the present proposal, there is an “electric vehicle navigation system (JP 3264123 B2)” that detects map information, GPS information, and a remaining capacity of a battery and controls driving of a generator mounted on a vehicle. This proposal is a technology utilizing a navigation system capable of driving the generator to charge the battery in a case where the vehicle is located near a pollution-free area and a remaining capacity of the battery is low and stopping the generator to prevent emission of exhaust gas in the pollution-free area, in order to cope with a problem that a conventional hybrid vehicle emits exhaust gas even in a pollution-free area due to driving of the generator mounted on the vehicle when the remaining capacity of the battery is low. As a result, it is claimed that emission of exhaust gas can be prevented as much as possible in a pollution-free area. However, in the PRE-EV vehicle using the planned electric power generation and storage control technology according to the present proposal, since modeling and a control method for reducing an electric power generation amount are used, the generator can be downsized, and a small-capacity secondary battery can be used. Thereby, an influence on the loading amount is limited. Therefore, the series hybrid technology can be utilized even in a commercial vehicle.

Note that, in the following description, the engine is assumed to be a diesel engine, but the engine is not limited thereto, and may be a gasoline engine, a fuel generator (so-called fuel cell), or the like.

### CITATION LIST

### Patent Literature

Patent Literature 1: JP 3264123 B2

Patent Literature 2: JP 2019-77257 A

Patent Literature 3: JP 2020-62906 A

### SUMMARY OF INVENTION

### Technical Problem

The problem to be solved by the present invention is a problem that, in the conventional series hybrid vehicle, in a case of mounting a large number of secondary batteries and a large generator to be mounted to prepare for a situation in which it is desired to avoid an engine operation (for example, a long tunnel, a hospital, or a school area, or the like), a case of traveling on a long steep hill, or the like, the number of seats is reduced in a bus and a cargo loading amount is reduced in a truck. Further, an engine for a large generator has a problem in reducing a fuel consumption amount and CO₂ emission proportional to the fuel consumption amount.

### Solution to Problem

In the present proposal, a use time of the secondary battery that is optimal for traveling and a state of charge of the secondary battery that is obtained by the engine generator are calculated using position information (latitude, longitude) and altitude information of the traveling route from map information and information such as average horizontal electric power consumption, an average speed, and a vehicle weight from the vehicle before traveling. Thus, a target value for an SOC (which is an abbreviation of “state of charge” and is an index representing an electric power storage amount, a charging rate, or a charging state, same below) is set, the SOC representing a state of charge of the secondary battery at the destination point, and an SOC chart representing a status of the SOC during traveling in a chart format is created.

Further, the present proposal includes a means for sequentially monitoring a state of electric power storage of the battery while the vehicle is traveling by using vehicle information and ICT such as GIS and GNSS, and recreating the SOC chart in a case where an SOC value during traveling deviates from the SOC chart by a set value or larger. That is, after the start of traveling, traveling is performed while correcting the initial traveling plan on the basis of the traveling information and the vehicle information that are sequentially obtained during traveling. As a result, charging of the secondary battery can be started and stopped at an optimum timing, and thus, a small engine generator and a small-capacity secondary battery can be used. Therefore, problems that have been faced so far, especially in the series hybrid commercial vehicle can be solved.

That is, the present invention provides a planned electric power generation and storage control device using an SOC chart and a planned electric power generation and storage control method using an SOC chart, as a planned electric power generation and storage control technology using an SOC chart for a so-called PRE-EV vehicle that performs traveling using a mounted battery by charging the battery of the vehicle using an engine generator and driving a motor using electric power of the battery, the technology including: a means for obtaining an electric power generation amount required for traveling on a traveling route when creating the SOC chart using traveling route information before traveling.

In the planned electric power generation and storage control technology according to the present invention, there may also be included a receiving means for giving a speed, electric power consumption, and a weight as provisional values in a case where the SOC chart is created using traveling route information before traveling and changing, when traveling, the electric power consumption, the speed, and the weight which can be acquired at a timing to the provisional values.

Further, it is assumed that the vehicle travels to a destination using a state of charge of the battery at a departure point in order to obtain a required electric power generation amount, and an absolute value of a value obtained by adding a required minimum electric power storage amount (SCL) of the battery to a negative electric power amount obtained from an SOC value at a destination point can be set, as an electric power generation amount required for traveling.

Further, in the SOC chart creation method, an SOC chart can be created by drawing an SOC line, the soc line representing a state of charge of the battery in traveling using the battery and being drawn by reverse drawing from a set SOC value at the destination point toward a departure point, repeating a process of performing switching to an electric power generation line in a case where an SOC value reaches a maximum electric power storage amount (SCH) and further performing switching back to the SOC line for traveling using the electric power storage amount of the battery in a case where an SOC value reaches a required minimum electric power storage amount (SCL), and setting a point at which the EV line for traveling using the battery from a departure point intersects with the electric power generation line, as a point at which the EV line is stopped and the electric power generation line is started.

In addition, the electric power storage amount of the battery at the departure point can take a value between the maximum electric power storage amount and the required minimum electric power storage amount.

In addition, in creating the SOC chart before traveling, it is also possible to set an electric power generation time and an electric power generation section such that the SOC chart is created within a range from the SCL to the SCH by early starting electric power generation early in a case where an SOC value may be equal to or lower than the SCL during traveling, early stopping electric power generation in a case where an SOC value may be equal to or higher than the SCH, and avoiding an electric power generation state in a silent section by generating a required electric power amount before entering the silent section in a case where the engine has to be driven in the silent section.

Further, the technology may further include a means (recreation means) for monitoring a difference from an SOC value from the SOC chart planned before traveling by using position information at a traveling point that is obtained from a position information collection device such as a GPS during traveling of the vehicle, vehicle information such as an SOC value representing a state of charge of the battery from the vehicle, and map information, and sequentially recreating the SOC chart during traveling in a case where the deviation value reaches a set value.

In addition, in a case where the traveling route is configured by a set of a plurality of sub-traveling routes when creating and recreating the SOC chart, the traveling state can be converted at the entrance or the exit of the small traveling route.

In addition, in creating the SOC chart before traveling, the SOC chart can be created using a set electric power consumption value that is worse than an assumed value and a set speed that is faster than the assumed speed, and the SOC chart can be recreated using the electric power consumption and the speed which are acquired from the vehicle during traveling.

In addition, the required electric power generation amount may include, as the electric power generation amount required for traveling, a value which is obtained by multiplying the number of times of reciprocation of the SOC chart between the SCH and the SCL of the battery by the available electric power storage amount of the battery (maximum electric power storage amount-required minimum electric power storage amount), and an electric power amount obtained by subtracting the value from the absolute value.

In addition, in a case where an installation place of the charger is known in advance on the traveling route on which traveling using the battery is performed, it is also possible to determine whether or not charging is to be performed by the charger and reflect a result in the SOC chart to be created before traveling.

Further, it is also possible to determine whether or not charging is to be performed by the charger by determining whether or not the charger is installed within a distance determined in a direction from a point at which the last point of traveling using the battery becomes the SCL to the departure point, whether or not a charging time for charging by the charger can be secured, and whether or not an operation plan is not disturbed.

In addition, the technology may further include a means (prediction means) for predicting that the vehicle cannot reach the destination even in a case where the SOC chart is corrected due to an unexpected situation during traveling, and a means for giving a driver a driving instruction adapted to the situation.

In addition, the driving instruction given to the driver may be an instruction for securing the electric power generation time by decelerating a traveling speed than the current speed, or an instruction for stopping the vehicle and performing electric power generation to secure the required electric power storage amount. An instruction means for performing such an instruction may be a display means such as a display that displays instruction contents, or may be an alarm device that issues an instruction to the driver by sound. Further, the prediction means can predict whether the vehicle can reach the destination on the basis of the current SOC and the SOC chart for the remaining traveling sections.

In addition, the technology may further include a means for recreating, in a case where the originally-scheduled traveling route is disturbed and diversion traveling is performed, the SOC chart adapted to the diversion traveling.

In addition, even in an EV vehicle using only a battery as an electric power source, the EV vehicle may include a means for creating an SOC chart incorporating traveling route information before traveling, sequentially comparing an SOC value at a point and an SOC value on the SOC chart during traveling, and notifying the driver of a charger installation place and a required charging amount.

In addition, the EV vehicle may include a means for maximizing the electric power storage amount of the battery at a predetermined point by allowing the vehicle to travel normally according to a traveling plan created before traveling and allowing, as necessary, the vehicle to perform switching to traveling with electric power generation to preferentially store the electric power in the battery.

Therefore, in order to solve the above problems, the present invention provides a planned electric power generation and storage control device using an SOC chart for a range extended EV that performs traveling using a mounted battery by charging the battery of the vehicle using an engine generator and driving a motor using electric power of the battery, the device including: an SOC chart creation means for creating an SOC chart required for traveling on a traveling route, which is set by traveling route information, by using the traveling route information, and a speed, electric power consumption, and a weight which are given as provisional values before traveling. The planned electric power generation and storage control device may further include an SOC chart correction means for correcting the SOC chart on the basis of a speed, electric power consumption, or a weight that can be acquired at the time of traveling.

Therefore, in order to solve the above problems, the present invention provides a planned electric power generation and storage control device using an SOC chart. That is, there is provided a planned electric power generation and storage control device using an SOC chart for a range extended EV (EV is an abbreviation for “electric vehicle”) that performs traveling using a mounted battery by charging the battery of the vehicle using an engine generator and driving a motor using electric power of the battery, the device including: an SOC chart creation means for creating an SOC chart required for traveling on a traveling route, which is set by traveling route information, by using the traveling route information, and a speed, electric power consumption, and a weight which are given as provisional values before traveling. The planned electric power generation and storage control device may further include an SOC chart correction means for correcting the SOC chart on the basis of a speed, electric power consumption, or a weight that can be acquired at the time of traveling.

Therefore, in order to solve the above problems, the present invention provides a range extended vehicle (also referred to as a range extended EV) including a planned electric power generation and storage control device using an SOC chart. That is, there is provided a range extended EV that performs traveling using a mounted battery by charging the battery of the vehicle using an engine generator and driving a motor using electric power of the battery, the range extended EV including: a control device that is for charging the battery of the vehicle by the engine generator, the control device being the planned electric power generation and storage control device according to the present invention. In particular, in a case where the vehicle can be charged from a charger and a charger is set on a traveling route, a plug-in range extended EV (hereinafter, referred to as PRE-EV) that creates a traveling plan considering charging (plug-in) by the charger can be used.

Therefore, in order to solve the above problems, the present invention provides a planned electric power generation and storage control method using an SOC chart. That is, there is provided a planned electric power generation and storage control method using an SOC chart for a range extended EV that performs traveling using a mounted battery by charging the battery of the vehicle using an engine generator and driving a motor using electric power of the battery, the method including: an SOC chart creation step for creating an SOC chart required for traveling on a traveling route, which is set by traveling route information, by using the traveling route information, and a speed, electric power consumption, and a weight which are given as provisional values before traveling; and an SOC chart correction step for correcting the SOC chart on the basis of a speed, electric power consumption, or a weight that can be acquired at a timing in traveling. The planned electric power generation and storage control method using such an SOC chart can be executed by a computer. That is, the present invention can be implemented by a computer program.

A mechanism for operating driving and stopping of the generator in a planned manner as described above is referred to as a planned electric power generation and storage control system, and a basic concept of the system will be described. The electric power amount supplied from the battery during traveling of the vehicle is used for driving electric power and auxiliary electric power. The driving electric power is energy that is against rolling resistance, aerodynamic resistance, acceleration resistance, and gradient resistance, and changes from moment to moment. The basis of the planned electric power generation and storage control system (hereinafter, the system is also referred to as the “present system”) is to determine the secondary battery capacity that can output instantaneous power of the drive motor and the driving force of the drive system when designing the vehicle, and to perform distribution calculation of the energy for consumption such that the vehicle can reach the destination within the capability range.

Therefore, the generator does not need to supply instantaneous power immediately, and it is sufficient that the generator can supply the electric power amount required between the current location and the destination. In this case, the battery is charged in a planned manner such that the required electric power amount can be supplied from the battery instantaneously. For example, in the vicinity of a lower limit value of the remaining electric power amount of the battery, charging is performed in advance such that required electric power can be instantaneously supplied, and in the vicinity of full charging, the generator is stopped before full charging such that a large regenerative electric power amount is prevented from being instantaneously generated. Since driving and stopping of the generator are performed in a planned manner, the SOC range to be used is set in accordance with the characteristics of the battery to create the SOC chart.

A calculation method of the system will be described below. During so-called EV traveling in which the vehicle travels using the battery, the electric power consumption amount P from the current location to the destination on the traveling route is calculated by being divided into an electric power amount Ph consumed for horizontal movement and an electric power amount Pv consumed for vertical movement, and insufficient electric power with respect to the current remaining electric power amount of the battery is calculated. For this insufficient electric power amount, the generator is driven in required minimum sections to secure the electric power generation amount Pg, and the vehicle performs traveling. The remaining electric power amount of the battery at the destination can be adjusted to the set value by controlling the generator by the planned electric power generation and storage control. Assuming that the remaining electric power amount of the battery at the current location is SOC, the SOC set value of the remaining electric power amount of the battery at the destination is the SCL, and the capacity of the battery is D, the remaining electric power amount of the battery is D. (SOC−SCL). Assuming that the electric power generation amount by the generator is Pg, a condition that the vehicle can arrive at the destination from the current location is that the available electric power amount is larger than the required electric power amount.

Thus, the following expression is established.
Pg+D·(SOC−SCL)>Ph+Pv

Therefore, the electric power amount to be generated is as follows.
Pg>Ph+Pv−D·(SOC−SCL)

Here, the factors are as follows.

Ph=distance A (km)/average electric power consumption C (km/kWh) of horizontal movement,

Pg=(output P of generator)·(electric power generation time tg), electric power generation time tg=(distance A)/(average speed v)

Therefore, in a case where the electric power consumption is deteriorated and the average vehicle speed is increased, the electric power generation time is shortened and a cruising distance is shortened. In addition, the following expression (1) is established.

Pv=(m·g·hu)−(k·m·g·hd) (1)

Here, m is a total weight of the vehicle, g is gravitational acceleration, hu is a cumulative upward elevation difference from the current location to the destination, and hd is a cumulative downward elevation difference. Therefore, in a case where the weight m is heavy, the cumulative upward elevation difference is large, and a regenerative coefficient k (to be described below) is small, the electric power amount Pv consumed for vertical movement increases, and thus, it is required to increase the output of the generator.

Here, a difference between the regenerative ratio and the regenerative coefficient k will be described. The regenerative ratio is a ratio of the electric power consumption amount Pd when the vehicle descends a hill with the same distance to the electric power consumption amount Pu when the vehicle ascends the same hill.
Pu=Phu+m·q·hu
Pd=Phd−k·m·g·hd

Here, Phu is an electric power consumption amount when the vehicle performs horizontal traveling, and Phd is an electric power consumption amount when the vehicle travels the same distance in the horizontal direction in the same manner. Therefore, in a case where a road condition, a weather condition, and the like are the same, Phu=Phd is satisfied. However, the same condition cannot be satisfied in actual traveling, and thus, Pd and Pu are considered as an independent term.

From the above, when the ratio of the electric power amount including the electric power consumption of traveling by horizontal movement on a hill is defined as the regenerative ratio, the regenerative ratio=Pd/Pu, and this value can be actually measured. On the other hand, assuming that the ratio of the electric power amount only in the vertical direction is defined as the regenerative coefficient k, the regenerative coefficient k=Pvd/Pvu is satisfied.

The regenerative coefficient k can be obtained by considering the following factors, but a value of k can also be adjusted from the SOC chart of the planned electric power generation and storage control system. Here, the electric power consumed for movement (Phu and Phd) is energy that is against (1) rolling resistance, (2) aerodynamic resistance, (3) acceleration resistance, and (4) gradient resistance. The regenerative ratio is a ratio of electric power consumed for downhill movement to electric power consumed for uphill movement when the vehicle reciprocates a route with a gradient. The regenerative ratio includes electric power required for horizontal movement both upward and downward, and thus, the regenerative ratio has a value smaller than the regenerative coefficient. In the planned electric power generation and storage control system, the electric power is calculated by dividing the electric power into a sum of (1) rolling resistance, (2) aerodynamic resistance, and (3) acceleration resistance, which is the electric power amount required for horizontal movement, and (4) energy against gradient resistance, which is the electric power amount required for vertical movement.

For example, when a hoisting machine is configured by the drive motor, the energy required to lift a weight having mass m by height h is Pvu=m·g·h, and the energy that can be recovered by the motor serving as a generator when the weight is lowered by height h is Pvd=k·Pvu (k<1). k is a value obtained by multiplying the efficiency of the motor/inverter and the charging efficiency of the battery. That is, k=(electric power generation efficiency of motor/inverter). (charging efficiency of battery).

The regenerative electric power is also generated when the vehicle decelerates. The regenerative coefficient k also represents a ratio between the electric power amount that can be recovered in a case where the vehicle decelerates from a speed 1 to a speed 2 without using a foot brake and the electric power amount that is required in a case where the vehicle accelerates from a speed 1 to a speed 2. That is, assuming that m is the total weight of the vehicle and Δv is a change amount in speed, the following expression is established.

The electric power amount required in a case where the vehicle accelerates from a speed 1 to a speed 2 is (½)·m·Δv².

The regenerative electric power amount that can be recovered in a case where the vehicle decelerates from a speed 2 to a speed 1 is k (½)·m·Δv².

Here, assuming that speed changes in acceleration and deceleration are the same, the electric power amount required for acceleration and deceleration from the departure place to the destination is (½)·m·(Σ(1−K)Δvn²). Assuming that the regenerative coefficient due to the previous movement in the vertical direction is k1 and the regenerative coefficient in acceleration and deceleration is k2, the total regenerative coefficient k is k=k1·k2.

Further, the electric power consumption amount (movement energy) required for traveling of the vehicle is expressed in more detail by a calculation equation. The movement energy R of the vehicle can be calculated by the following expression (2).

The electric power consumed for horizontal movement R1 can be calculated by the following expression (2). There is energy against the acceleration resistance, but the energy is 0 for traveling at a constant speed. Since the gradient resistance R3 is Pv, the following calculation can be performed.
The rotation speed and the torque used for calculating the electric power consumption of the motor are calculated from a speed of a traveling pattern and vehicle data.
rotation speed Nt (rpm) of the motor at a timing t:
Nt=(1000·im·Vt)/2πr

For example, im: reduction gear ratio (4.555), r: dynamic load radius (0.385 m) of a tire, Vt: vehicle speed (km/h) at a timing t
shaft torque Tmt (N·m) of the motor at a timing t:
Tmt=(9.8·r·R)/(im·η)
R=R1 (rolling resistance+air resistance)+R2 (acceleration resistance)+R3 (gradient resistance)

=(μr·W+μa·A·Vt2)+((W+ΔW)/9.8))·(Vt−Vt−1)/3.6)+(9.8·(W+ΔW)·(ht−ht−1)) (2)

Here, an example of each parameter value will be described.
im: reduction gear ratio (4.555),
η: transmission efficiency of a speed reducer (0.95),
ht−1: altitude one second before a timing t (in a case of traveling on a road with a slope)
Vt−1: vehicle speed one second before a timing t (km/h)
μr: rolling resistance coefficient (kg/kg) μr=0.008210
μa: air resistance coefficient (kg/m²/(km/h)²)
μa=0.002846
A: front projection area (m2) A=2.26×2.55=5.085
W: mass of vehicle when test, in a case of truck {mass of empty vehicle+full load mass/2+55 (one person)} (kg) 5715 kg
ΔW: equivalent mass of rotation portion (kg) 2178.5 kg

Calculation of electric power consumption of the motor: electric power consumption can be simulated from the rotation speed and torque. When the movement energy R of the vehicle becomes negative, a counter electromotive force is generated, and the counter electromotive force is accumulated in the secondary battery, as regenerative electric power.

As described above, the electric power consumption (movement energy) of the vehicle is represented by the expression (1), and is a function of a height difference (ht−1) that changes within the unit time (here, one second) and a speed difference (Vt−1) that is similar to the height difference. The planned electric power generation and storage control system uses the horizontal traveling speed, the electric power consumption, the weight, and the like as provisional values in order to create the SOC chart before traveling. On the other hand, as the vehicle travels, the speed, the electric power consumption, and the altitude at a timing can be obtained, and thus, the SOC chart is recreated during traveling by using these values.

### BRIEF DESCRIPTION OF DRAWINGS

FIG. 1A is an overall block diagram of a planned electric power generation and storage control system.

FIG. 1B is a flowchart of processing in the planned electric power generation and storage control system.

FIG. 2 is a diagram illustrating a method of estimating a required electric power generation amount using an SOC chart.

FIG. 3 is a diagram illustrating a method of setting a required electric power generation amount during traveling.

FIG. 4 is a diagram for obtaining an SOC chart by reverse drawing from a destination point toward a departure point.

FIG. 5 is an SOC chart in a case where traveling is performed using an electric power amount of a battery from a departure point to a required minimum electric power storage amount SCL of the battery and traveling with electric power generation is performed such that a target SOC value at a destination is obtained.

FIG. 6A is a diagram illustrating a method of obtaining the SOC chart of FIG. 4 by reverse drawing and a method of obtaining the SOC chart by calculation.

FIG. 6B is a diagram illustrating a method of obtaining, by calculation, the SOC chart of FIG. 4 in a case where electric power generation is performed three times between the SCL and the SCH.

FIG. 7 is an SOC chart illustrating that, in a case where there is a silent section during traveling, electric power generation sections are arranged before and after the silent section.

FIG. 8 is a diagram illustrating an electric power generation start section in a case where there is a steep uphill during traveling and an SOC decreases even when electric power generation is performed.

FIG. 9 is a diagram illustrating an electric power generation start section to avoid waste of regenerative electric power in a case where there is a steep downhill during traveling.

FIG. 10 is a diagram illustrating an electric power generation section for avoiding an engine operation in a silent section during traveling.

FIG. 11 is a diagram illustrating that, in a case where a charger is installed in the middle of traveling, traveling is performed using an electric power storage amount of a battery from a departure point to the charger and the battery is charged to the SCH by the charger.

FIG. 12 is an SOC chart in a case where charging is performed by a charger during traveling and then traveling to a destination point is performed using an electric power storage amount of a battery.

FIG. 13 is an SOC chart in a case where charging is performed by a charger during traveling and electric power generation is performed during traveling to a destination point.

FIG. 14 is a diagram obtained by drawing a form of an actual SOC chart.

FIG. 15 is a diagram illustrating a method of correcting an SOC chart in each section during traveling.

FIG. 16A is a diagram illustrating another method of recreating an SOC chart and illustrating an SOC chart before traveling.

FIG. 16B is a diagram illustrating another method of recreating an SOC chart and illustrating a process of correcting an SOC chart in initial EV traveling.

FIG. 16C is a diagram illustrating another method of recreating an SOC chart and illustrating a process of correcting an SOC chart in traveling with electric power generation.

FIG. 16D is a diagram illustrating another method of recreating an SOC chart and illustrating a process of correcting an SOC chart in EV traveling to a destination.

FIG. 17 is a diagram illustrating a method of recreating an SOC chart.

FIG. 18 is a diagram illustrating a course of creating an SOC chart by reverse drawing in a case where a traveling route from a departure point to a destination point is configured by sections with non-constant distances.

FIG. 19 is a diagram illustrating an adjustment method in a case where traveling from a departure point is performed using an electric power storage amount of a battery and an EV traveling line intersects with an SOC line created from a destination point to a departure point by reverse drawing.

FIG. 20 is a diagram illustrating an adjustment method in a case where traveling from a departure point is performed using an electric power storage amount of a battery and an EV traveling line does not intersect with an SOC line created from a destination point to a departure point by reverse drawing.

FIG. 21 is a diagram illustrating, in a case where there is a silent section in the middle of a traveling route, an SOC creation method for avoiding traveling with electric power generation in the silent section.

FIG. 22 is a diagram illustrating, in a case where there is a steep uphill at which an SOC value decreases even when charging is performed in the middle of a traveling route, an SOC creation method for avoiding an electric power shortage at the uphill section.

FIG. 23A is a diagram illustrating a process of creating an SOC chart in a simulation by VBA created as verification before program coding using EXCEL, and illustrates a process of creating an SOC chart by reverse drawing from a destination point.

FIG. 23B is a diagram illustrating a process of creating an SOC chart in a simulation by VBA created as verification before program coding using EXCEL, and illustrates that electric power generation is performed while avoiding a silent section in the middle of a traveling route.

FIG. 23C is a diagram illustrating a process of creating an SOC chart in a simulation by VBA created as verification before program coding using EXCEL, and illustrates that EV traveling is started from the SCH toward a destination after the SOC chart is created to a departure point by reverse drawing.

FIG. 23D is a diagram illustrating a process of creating an SOC chart in a simulation by VBA created as verification before program coding using EXCEL, and illustrates that creation of the SOC chart is completed.

### DESCRIPTION OF EMBODIMENTS

Hereinafter, a planned electric power generation and storage control technology using an SOC chart according to the present embodiment (that is, a planned electric power generation and storage control device and a planned electric power generation and storage control method) will be specifically described with reference to the drawings.

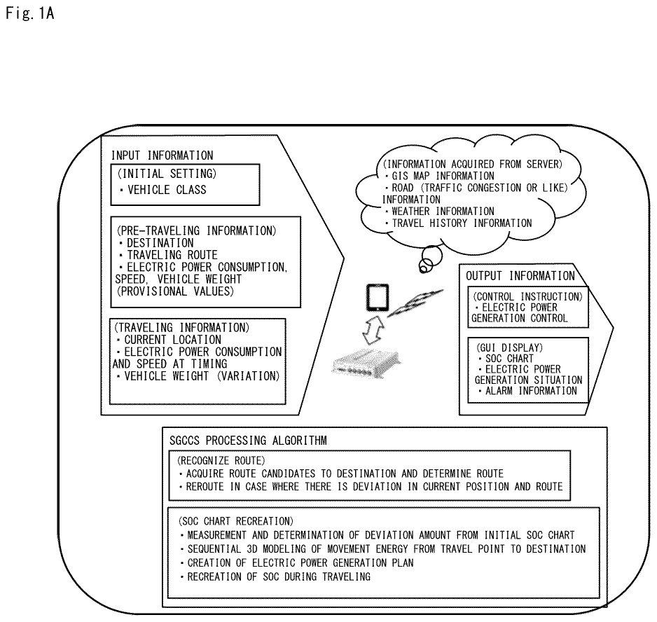

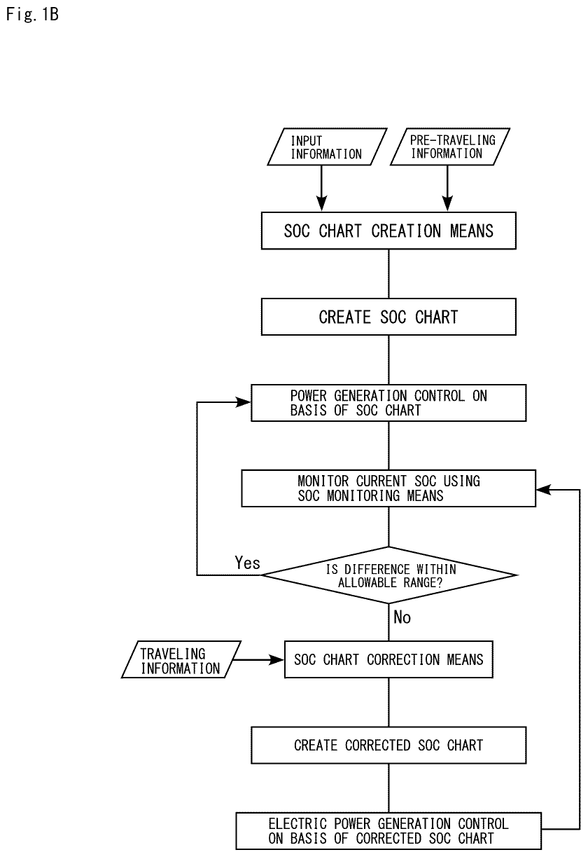

FIG. 1A is an overall block diagram of a planned electric power generation and storage control system (that is, an electric power generation and storage control device). The planned electric power generation and storage control system can be configured by a computer such as an engine control unit (ECU), and includes at least an SOC chart creation means. The SOC chart creation means acquires, as input information, initial setting information such as a vehicle class for specifying information related to traveling of the vehicle, a destination, a traveling route (traveling route information), pre-traveling information such as provisional electric power consumption, a speed, and a vehicle weight, a current position, a state of charge (SOC) indicating a state of charge of the secondary battery, and traveling information such as electric power consumption, a speed, and a vehicle weight (variation) at each timing. Then, according to a planned electric power generation and storage control algorithm which is a core of the system, in order to recognize a traveling route, acquisition of a route candidate to a destination, determination of a route, and creation of a reroute in a case where the vehicle deviates from the route are performed. Further, in order to recreate an SOC chart, measurement of a deviation amount from an initial soc chart, sequential three-dimensional modeling of movement energy from a traveling point to a destination, creation of an electric power generation plan, recreation of an SOC chart, and the like are performed. Further, control instruction information such as electric power generation control, an SOC chart, and graphical user interface display information such as an electric power generation situation and alarm information are output as output information.

The SOC chart creation means creates an SOC chart according to the traveling route (traveling route information) on the basis of initial setting information such as a vehicle class for specifying information related to traveling of the vehicle, a destination, a traveling route (traveling route information), and pre-traveling information such as provisional electric power consumption, a speed, and a vehicle weight. Then, an SOC chart correction means creates a corrected SOC chart by correcting the SOC chart that is initially created on the basis of the traveling information acquired while the vehicle is traveling. In particular, the input information includes electric power consumption, a speed, and a vehicle weight as provisional values (parameters) set before traveling. These values are updated as traveling information, and the electric power consumption and the speed at each timing, and a change in the vehicle weight due to loading and unloading of cargoes during traveling are acquired. The traveling information is used for recreation of the SOC.

Thereby, since a more accurate recreated SOC chart can be used for traveling after the timing, a deviation from an SOC value to be observed during traveling can be reduced. Thus, the number of times the generator is turned on and off can be reduced, and when the vehicle reaches the destination, the vehicle can travel at a value closer to the SOC value set before traveling. When the generator is turned on, it takes several tens of seconds to several minutes until the generator reaches a stable state, and during the time, there is a problem such as an increase in the electric power consumption amount and the CO₂ emission amount. As a result, it is required to minimize the number of times the generator is turned on and off.

As described above, in a case where the charge amount of the secondary battery decreases, the PRE-EV vehicle drives the engine to charge the secondary battery, or charges the secondary battery from the charger in the middle of the traveling route. Therefore, unlike an EV vehicle, there is no concern about an electric power shortage during traveling. Thus, it is possible to eliminate restriction of a traveling distance, which is a problem of the EV vehicle, and a vehicle with very good usability can be obtained. Further, since the PRE-EV vehicle travels using a motor driven by electric power of the secondary battery in a large proportion of the traveling time, carbon dioxide emission can be greatly reduced as compared with a vehicle driven by a normal engine. Further, engine noise from the internal combustion engine is limited, and thus, the PRE-EV vehicle is also quiet and comfortable to ride in a significant traveling time. Since the maintenance cost including the fuel cost is lower than the maintenance cost of a diesel engine vehicle, it is considered that the advantage of introduction is large.

On the other hand, in order to create an SOC chart before traveling, required data (a destination, average electric power consumption, an average vehicle speed, vehicle information, and the like) should be entered into the planned electric power generation and storage control system (hereinafter, referred to as “scheduled generating and charging control system (SGCCS)”, but this work will be carried out by an office staff member or a driver. However, since the driver is accustomed to driving of a normal diesel truck, it can be expected that the driver will dislike the extra time and effort of inputting data for SGCCS traveling. Therefore, a method of inputting data required for SGCCS traveling on that day to an SOC chart creation PC (SGCCS PC) for a truck without bothering the driver as much as possible will be described below.

The input data includes the following items.
(A) Destination
(B) Electric power consumption (influenced by a cargo weight, but first, a standard electric power consumption value)
(C) Vehicle speed (varies depending on a traveling route such as traveling on an expressway, but first, a standard vehicle speed)
(D) SOC (current electric power storage amount)
(E) Cargo weight (or a total vehicle weight)
(F) Weather condition (a weather, a temperature, and the like)
(G) Prediction of use of auxiliary device
(H) Stopover

At this time, among these pieces of data, items managed by the office are (A), (B), (C), (E), (F), and (H). (D) is data in the PC (SGCCS PC) that is for creating an SOC chart and is installed in the vehicle, but can also be managed in the office. In (G), the prediction of use of an auxiliary device depends on the traveling condition and the weather condition (F).

Therefore, a method for reducing a burden on the driver as much as possible will be described in the following means 1 to 3. In this case, the means serve as means for inputting various data to the SGCCS PC mounted on the vehicle.

(1) The driver receives a device (a tablet, a USB memory, or the like) to which the data related to the day is input from the office, gets into the vehicle, and turns on an activation switch of the truck. Thus, the SGCCS PC is activated, and the data in the device is transmitted to the SGCCS PC by the following means (2).

(2) The transmission method is performed by, for example, automatic transmission using near-field wireless communication such as BlueTooth (registered trademark), or in a case of USB, insertion by the driver into a USB insertion port of the PC.

(3) The weather condition (F) is acquired from the weather information web via the Internet, and at the same time, the prediction (G) of use of an auxiliary device is performed.

By reducing the burden on the driver as much as possible in this way, it is possible to promote the spread from a normal diesel truck to a PRE-EV vehicle (truck).

FIG. 1B is a flowchart illustrating a flow of processing in the planned electric power generation and storage control device using the SOC chart according to the present embodiment. As illustrated in FIG. 1B, the planned electric power generation and storage control device acquires initial setting information such as a vehicle class, the destination and the traveling route information, and pre-traveling information including a vehicle speed, electric power consumption, and a vehicle weight. The SOC chart creation means creates an initial SOC chart from the initial setting information and the pre-traveling information. Then, the engine generator included in the range extended EV is operated to charge the battery of the vehicle on the basis of the SOC chart. Then, in the present embodiment, an SOC monitoring means of the planned electric power generation and storage control device compares or calculates a difference between the initially-created SOC chart and the current SOC on the basis of the current position during traveling and the state of charge (SOC) indicating a state of charge of the secondary battery. Then, in a case where the difference exceeds an allowable range, the SOC chart correction means corrects the initially-created SOC chart on the basis of the current position, the state of charge (SOC) indicating a state of charge of the secondary battery, and the traveling information such as electric power consumption, a speed, and a vehicle weight (variation) at each timing, and creates a corrected SOC chart. Then, the corrected SOC chart can be replaced with the initially-created SOC chart, and a difference or the like from the SOC chart can be continuously calculated. Thus, the SOC chart can be appropriately corrected. Thereby, for example, the planned electric power generation and storage of the range extended EV can be controlled on the basis of the latest SOC chart according to the change in vehicle weight and the electric power consumption based on the speed.

On the other hand, although the vehicle weight changes due to loading and unloading of cargoes during traveling, in a case where a vehicle weight meter that detects a change in the vehicle weight is installed in the vehicle, a value of the vehicle weight at the timing is automatically transmitted to the SGCCS PC, and thus, the vehicle weight item can be handled accurately and with reduced time and effort. As a place for installation, for example, it is considered to incorporate a sensor for detecting a change in air pressure of a tire into a tire portion.

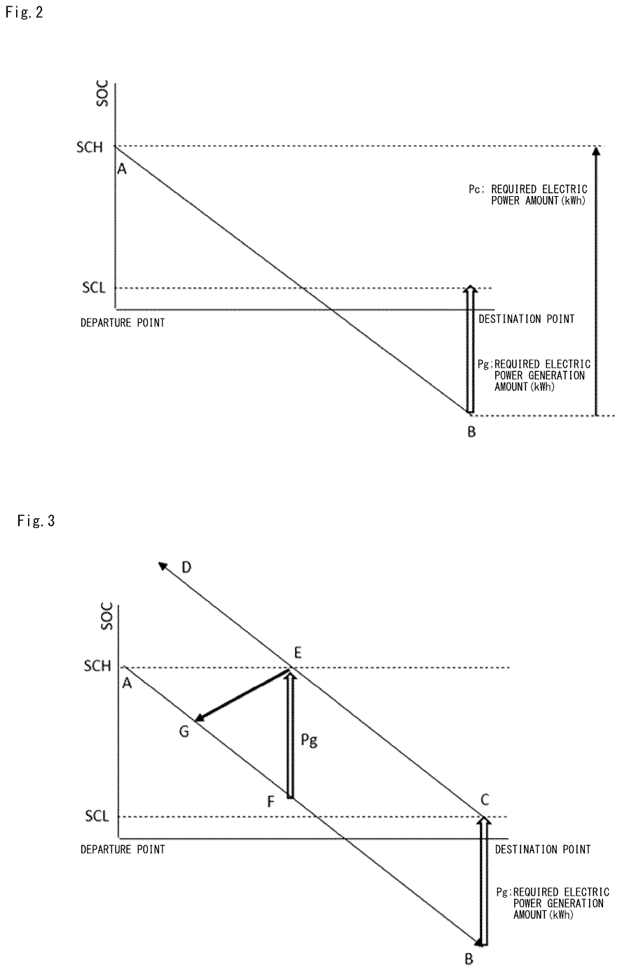

FIG. 2 to FIG. 13 show a process (algorithm) of creating an SOC chart before traveling, and the process can be executed by a computer or the like. Although the Soc chart in the drawings is illustrated as a straight line for simplification, the SOC chart cannot be actually formed as a straight line due to a state of the traveling route, a driving situation of the generator, and the like, and this form is schematically illustrated in FIG. 14.

In FIG. 2, a horizontal axis represents a distance or a time from a departure point to a destination point, and a vertical axis represents a state of charge (SOC) of the secondary battery. In addition, the SCH represents a maximum electric power storage amount of the battery, and the SCL represents a required minimum electric power storage amount of the battery. The required electric power amount Pc is the total electric power amount required for traveling the traveling route.

Although the electric power amount SCH is stored in the battery at the departure point, the state of charge (SOC) decreases as the vehicle travels. A straight line A-B represents a decrease in SOC, and has a negative value at the destination point. In this traveling, since traveling cannot be performed only with the state of charge of the battery, it is required to store electric power in the battery by electric power generation in the middle of traveling, and the required electric power generation amount is an electric power amount Pg indicated by an arrow from B to the SCL above.

FIG. 3 shows one method of drawing a required electric power generation amount in a chart between the SCL and the SCH. A straight line C-D is obtained by translating the straight line A-B upward by the required electric power generation amount Pg. At this timing, when a point at which the straight line C-D intersects with the SCH line is E, E-F has the same electric power generation amount as Pg. Therefore, the E-G line representing electric power generation is drawn from E to the original A-B line, but a slope of the E-G line depends on the electric power generation capacity of the generator. Since the vehicle travels by driving the engine generator during a period G-F, the SOC value increases from G to E due to electric power storage, and electric power required for traveling to a point F is consumed. As a result obtained by drawing the SOC chart in this way, the SOC chart becomes A-G-E-C. In A-G and E-C, EV traveling is performed by the state of charge of the battery, and in a G-E period between A-G and E-C, the vehicle travels while driving the engine generator to store the electric power in the battery.

FIG. 4 is a method of drawing the SOC chart illustrated in FIG. 3, in which the EV traveling line (D-C) is drawn by reverse drawing from the destination point, the line is switched to an electric power generation line (C-X) at a point at which the line reaches the SCH, and a point X at which the line intersects with the EV traveling line (A-B) from a departure point is set as an electric power generation start point. The method of drawing the soc chart is intuitive because the SOC chart can be obtained by reversely drawing the line from the destination point back to the destination point.

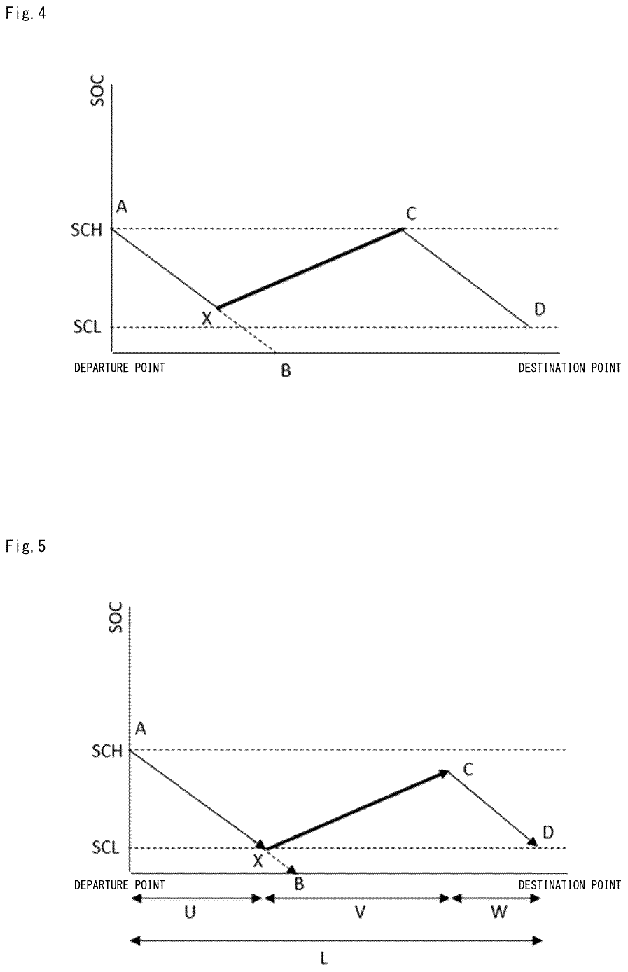

FIG. 5 illustrates a form in which the EV traveling from the departure point is continued to the SCL, electric power generation is started when the SOC reaches the SCL, and electric power generation is performed up to a point at which the SOC becomes the SCL at the destination point.

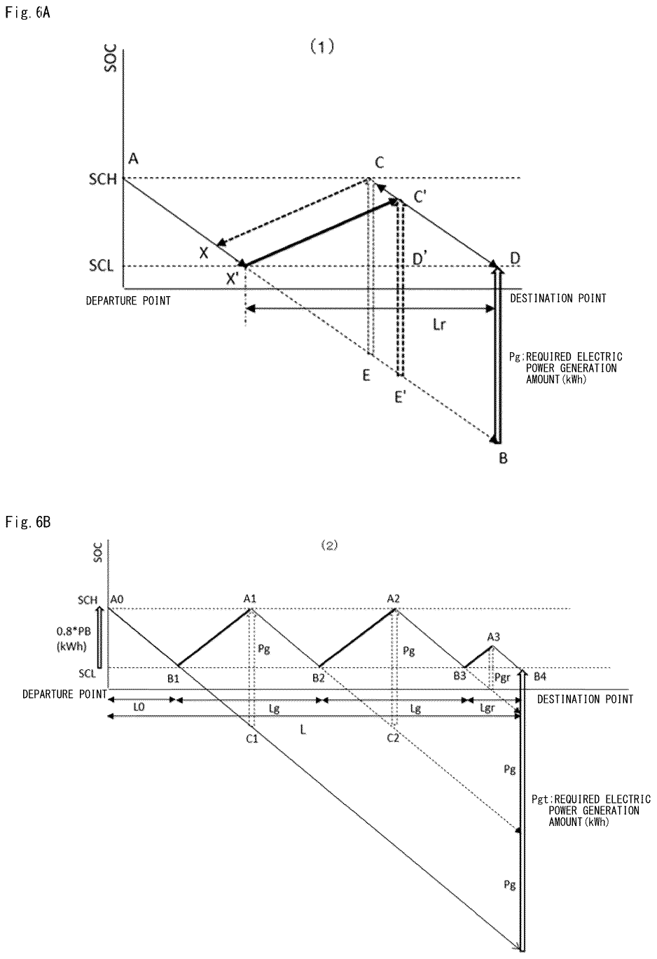

FIG. 6A illustrates a method of drawing FIG. 5. Similarly to FIG. 4, FIG. 6A illustrates that the SOC chart becomes A-X′-C′-D by sliding the electric power generation line (C-X) to X′ at which the electric power generation start X reaches the SCL, from a thin broken arrow line (C-E), which is obtained by translating the required electric power generation amount Pg to the SCH, toward the destination point.

Further, in order to create the SOC chart by calculation, it is required to obtain the electric power generation start point (X′), and a distance (Lr) from the start point to the destination point is obtained. Here, in a case where it is assumed that the electric power generation capacity of the generator is Pw and the average speed is v, a time required to travel the distance Lr is Lr/v. Thus, Pg=Pw·Lr/v, and the following equation is established.
C electric power consumption [km/kWh]
v traveling speed [km/h]
Pw electric power of generator [kW]
PB maximum electric power storage capacity of battery [kWh]
SCH ratio [%] of maximum electric power storage amount of battery, for example, 90%
SCL ratio [%] of required minimum electric power storage amount of battery, for example, 10%

Lr=(Pg·v)/Pw

FIG. 6A illustrates a case where the electric power generation period is once, but when the traveling distance is long, the electric power generation is repeated several times. FIG. 6B illustrates an example in which the electric power generation period is three times, and illustrates a case where the traveling mode is switched to the EV traveling (A3-B4) before the SOC reaches the SCH in the last electric power generation.

The electric power generation amount (Pgr) required for the last electric power generation period is obtained as follows. In L0, the vehicle travels with the state of charge of the battery at the start of traveling. Thus, in a case where it is assumed that L is the total traveling route length, the electric power generation amount (Pgt) required for the remaining traveling is as follows.

Pgt=(L−L0)/C

In a case where it is assumed that the maximum electric power storage amount of the battery is PB and the maximum available electric power amount (80%) is from the SCL to the SCH, L0=(0.8·PB)·C is obtained. Further, assuming that the electric power generation amount per unit time is constant, the electric power generation amount (Pg) is expressed by the following equation in a case where it is assumed that Pw is the electric power generation amount of the generator, tg is the number of data acquisition points from the SCL of B1 to the SCH of A1 in the electric power generation period, and T is the data acquisition cycle (seconds).

Pg=Pw·tg·T/3600

Therefore, the last electric power generation amount (Pgr) is as follows.

Pgr=Pgt−2·Pg=(L−L0)/C−2·(Pw·tg·T/3600)

Note that the electric power consumption C increases or decreases depending on the state of the traveling route. The most influential factor is the slope of the traveling route. In a case of traveling in the horizontal direction, the traveling force to overcome frictional resistance is mainly required. In a case of uphill traveling, the potential energy in the vertical direction is added, and thus, the electric power consumption is decreased. On the contrary, in a case of downhill traveling, the potential energy is drawn, and thus, the electric power consumption is increased. The following equation is a relational expression in a case where the horizontal electric power consumption is CR and the electric power consumption in consideration of the slope is CZ.

CZ=CR/(1+(D/100)·(M·g·CR))

Here, D is a coefficient (%) indicating a degree of the slope, and in a case where there is a height difference in the vertical direction by h when the vehicle travels a distance L, the relationship is as follows.

D=h/L

In addition, M is a vehicle weight, and g is 9.81 m/s² as an acceleration coefficient. In each unit, the electric power consumption is km/kWh, and the weight is kg. Therefore, on a traveling route with a slope, the previous electric power consumption C [km/kWh] can be replaced with CZ to perform calculation in consideration of a height difference in the traveling route.

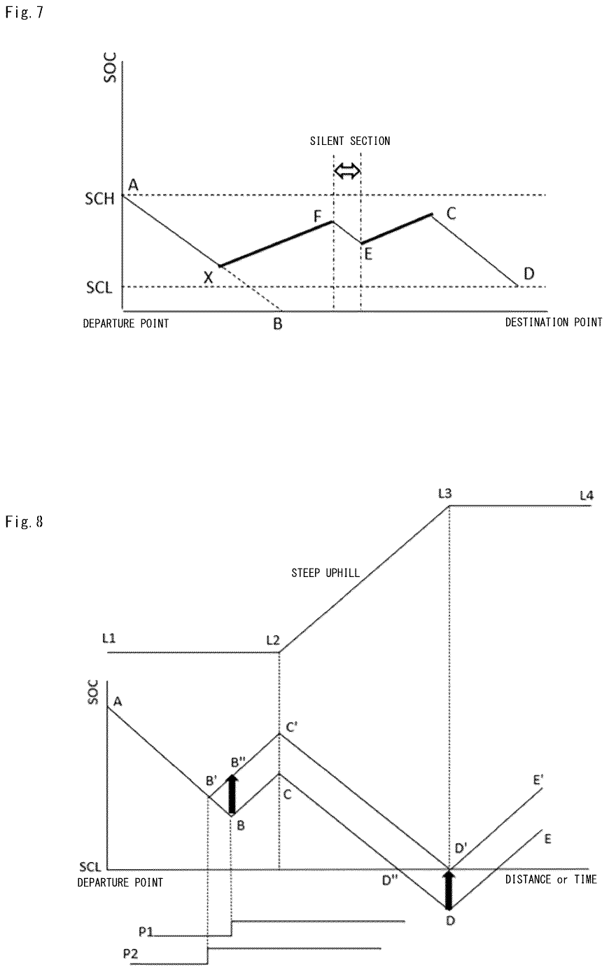

FIG. 7 illustrates a region in which an operation of the engine is to be avoided during traveling, the region being defined as a silent section, for example, a long tunnel, a certain city range, a hospital, a school area, or the like. Since the engine generator is stopped in this section, an electric power generation section is divided into a first half (X-F) and a second half (E-C).

On the other hand, in the planned electric power generation and storage control technology, by setting an electric power generation time and an electric power generation section in a planned manner, it is possible to downsize the engine and the generator motor and reduce the capacity of the secondary battery, and thus, the volume occupied by the engine, the generator motor, and the secondary battery can be reduced. Therefore, the number of passengers in a case of a bus and the loading amount in a case of a truck have performance comparable to performance of a normal vehicle. However, it is required to pay attention to downsizing of the motor and the battery in a situation in which a large amount of electric power is instantaneously used such as a steep long uphill. Hereinafter, specific adaptation examples of the planned electric power generation and storage technology for three traveling patterns will be described with reference to the drawings.

FIG. 8 illustrates a case where there is a steep uphill in the middle of the traveling route, for example, an example in which the SOC decreases during ascending because the electric power consumption during traveling is larger even in a case where the battery is charged by the engine generator. An upper portion of FIG. 8 indicates a traveling route, and a section from L2 to L3 is a steep uphill. A center portion indicates the SOC, and even in a case where the vehicle travels from A to B in EV traveling and starts electric power generation at B, the SOC decreases as shown in C-D on a steep uphill from L2 to L3, and the SOC becomes equal to or lower than the SCL in the D″-D section before the vehicle goes up the uphill. As a result, the vehicle is in an electric power shortage state. In order to avoid the electricity shortage state, by starting electric power generation from B′ on the SOC chart before traveling, the SOC chart can be A-B′-C′-D′-E′. That is, it can be seen that the electric power amount D-D′ that is equal to or lower than the SCL can be generated in advance as the electric power amount B-B″ in a flat land L1-L2 section. P1 and P2 indicate electric power generation sections, and while P1 indicates electric power generation from B, P2 indicates that electric power generation is started at B′ in front.

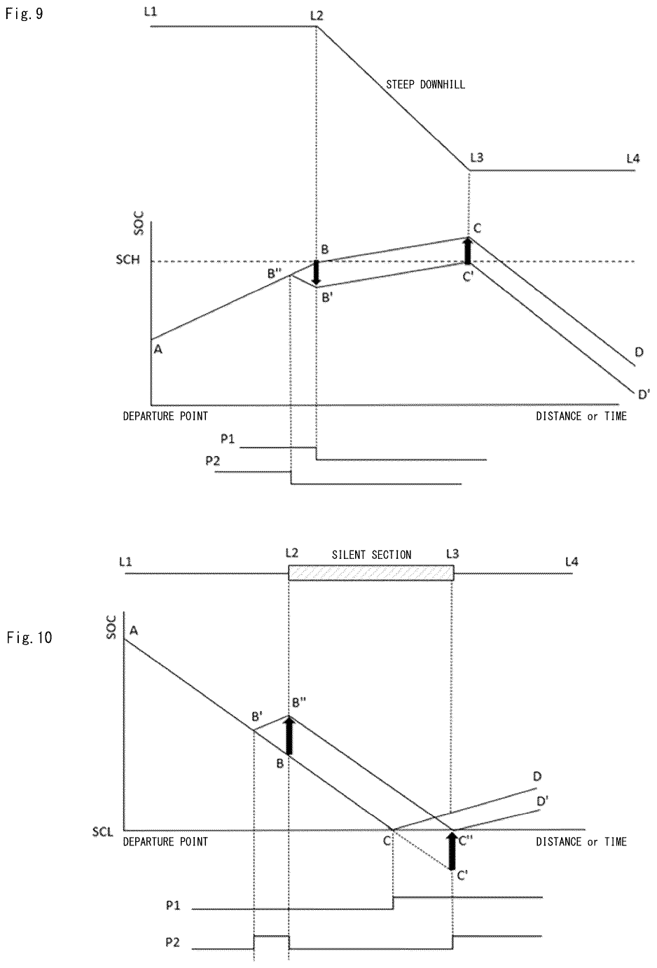

FIG. 9 illustrates a case where there is a steep downhill where regenerative electric power is expected to be generated during traveling. Since the L2-L3 section is a steep downhill, for example, in a case where the electric power generation section in the SOC is from A to B, for example, even though the electric power generation is stopped at B and the traveling is switched to EV traveling, due to regenerative electric power, the vehicle tries to store, in the battery, the electric power amount that corresponds to C′-C and is equal to or higher than the SCH. However, since the electric power amount equal to or higher than the SCH cannot be charged, the electric power amount has to be discarded. Therefore, the regenerative electric power amount C′-C is replaced with the electric power consumption amount B-B′ by stopping electric power generation at B″ and switching the traveling mode to EV traveling without generating electric power at B. Thereby, the SOC chart can be A-B″-B′-C′-D′. P1 and P2 indicate electric power generation sections, and while P1 indicates that electric power generation is performed to the SCH at B, P2 indicates that electric power generation is stopped at B″ in front.

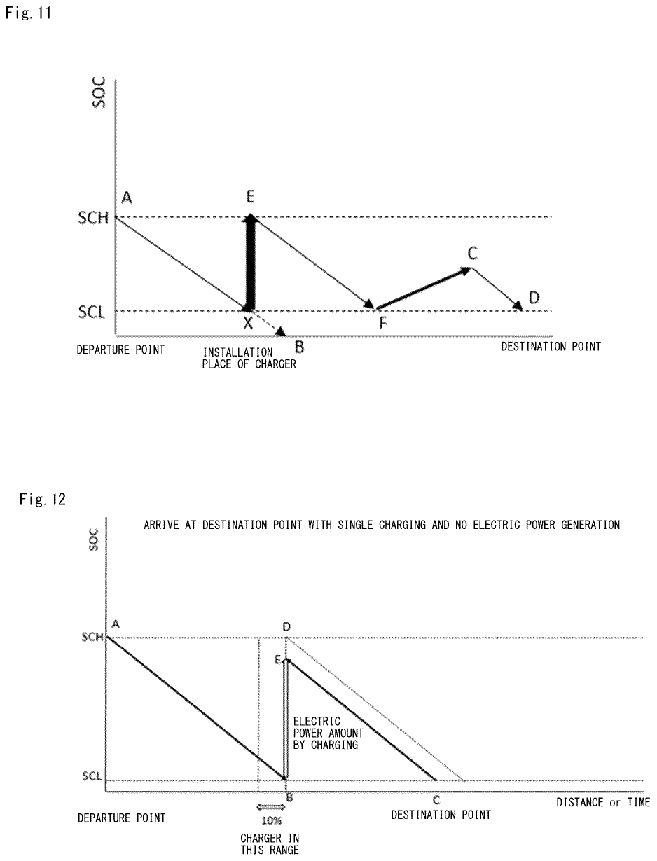

FIG. 10 illustrates a case where there is a silent section during traveling. The SOC chart that is made without considering the silent section is A-B-C-D. Even though the C-C″ section is a quiet section, electric power generation should be performed at a point C such that the SOC does not become equal to or lower than the SCL. In order to avoid this situation, the electric power generation amount C-C″ is preset to B″-B″. Thus, the vehicle can travel without generating electric power at C, and the SOC chart becomes A-B′-B″-C″-D′. The electric power generation amount B-B″ is equal to the insufficient electric power generation amount C-C″ in a case where the initial soc line becomes C-C′. The electric power generation sections are indicated by P1 and P2. The reason why the electric power generation period (B′-B″) in P2 is shorter than the electric power generation period (C-C′) in P1 in which the equivalent amount of electric power is generated is that the electric power storage amount of the battery is added to the electric power generation amount in the B′-B section.

FIG. 11 illustrates a state (X-E) where the battery is charged at a point X to recover the state of charge of the battery to the SCH since it is known that the charger is installed at the point X in the middle of the traveling route when creating the SOC chart before traveling. FIG. 11 illustrates a situation in which EV traveling is performed from the departure point and the charger is installed at a point at which the state of charge of the battery becomes the SCL. However, of course, even in a case where the charger is installed at a point before the state of charge of the battery reaches the SCL, it is possible to create a traveling plan so as to perform charging by the charger in consideration of the delivery schedule of the day.

FIG. 12 is a diagram illustrating an algorithm in a case where charging is performed by a charger during traveling in FIG. 11, and illustrates a case where the vehicle can reach a destination point without performing electric power generation by a mounted generator in a case where charging is performed during traveling. In a case where it is assumed that EV traveling (A-B) is performed with the state of charge of the battery from the SCH at the departure point to the SCL, the charger is installed just at the point B or slightly before the point B, and thus, a plan is created to perform charging with the charger. In addition, in a case where the EV line (C-E) is created by reverse drawing from the destination point toward the departure point, since the EV line (C-E) intersects (E) in the middle of the charging line (B-D) by the previous charger, the charging amount of electric power is set from B to E. Therefore, the SOC chart created before traveling becomes A-B-E-C.

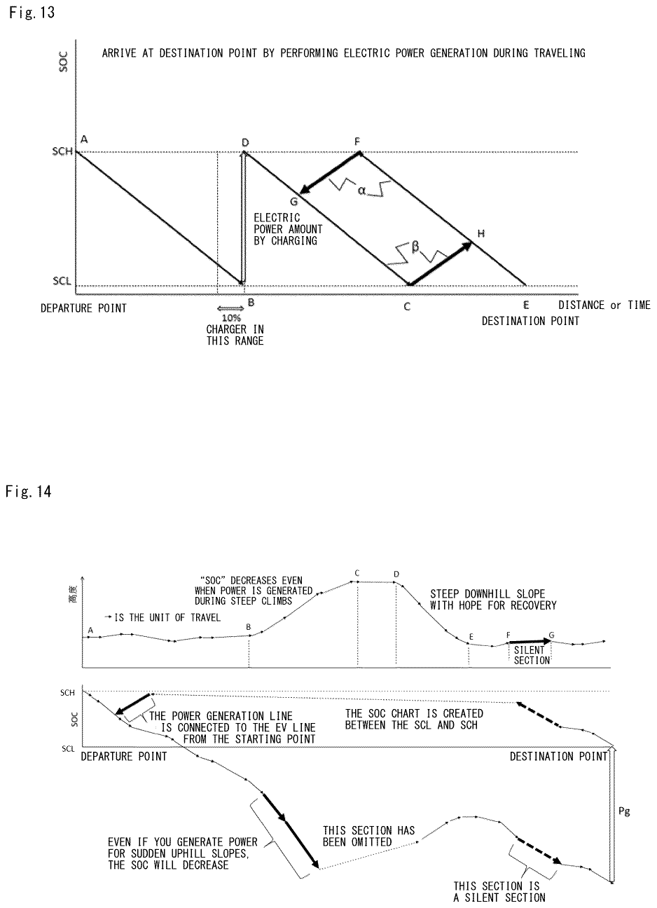

FIG. 13 illustrates a case where electric power generation is required during traveling to a destination point even in a case where charging is performed on the way. Similarly to FIG. 8, EV traveling is performed from the departure point to the SCL, and full charging to the SCH (B-D) is performed by the charger. At the same timing, an SOC chart for EV traveling is created by reverse drawing from the destination point toward the departure point, and when the vehicle reaches the SCH (F), the line in the soc chart is switched to the electric power generation line. A point (G) at which the electric power generation line intersects with the EV line (D-C) after charging is set as an electric power generation start point. As a result, the SOC chart becomes A-B-D-G-F-E. Alternatively, after charging, EV traveling (D-C) is performed up to the SCL, electric power generation is started at the point C, and electric power generation is stopped at a point intersecting with the EV line (E-F) drawn by reverse drawing from the destination point. The SOC chart in this case becomes A-B-D-C-H-E. As a matter of course, an electric power generation line parallel to C-H or F-G can be drawn as long as the charging amount is inside the rhombus H-F-G-C.

Note that, since there are many cases where the charger is not installed at the point which is the SCL when EV traveling is performed in the initial stage, it is required to consider whether charging should be performed only in a case where there is a charger within a certain distance back from the point B which is the SCL towards the departure point. FIG. 13 illustrates an example in which charging is performed as long as the distance is within 10% of the distance from the departure point to B, but the distance is not limited to 10%.

In a case where there is a charger before the point B and charging is performed there, charging is started without performing traveling to the SCL using the battery. At the timing, the charging line B-D in FIG. 13 approaches the departure point.

FIG. 14 is a diagram obtained by simulating an actual traveling route including silent sections assuming an uphill, a downhill, a tunnel, and the like during traveling. An upper portion in FIG. 14 illustrates a cross-sectional view of the traveling route, fairly steep uphill and downhill are assumed in the middle of the traveling route, and a silent section exists in the second half.

A lower portion in FIG. 14 illustrates the SOC chart, and the SOC chart decreases from the SCH. A thick line indicates an electric power generation period in the middle of the drawing, but even in a case where electric power is generated, the electric power is not stored in the battery due to a steep uphill, and the SOC continues to decrease. There is a silent section in the second half, and this section in FIG. 14 is an EV traveling section. However, in a case where there is a risk of electric power generation in the silent section, the electric power generation period is shifted before and after the silent section, and the silent section is set not to perform electric power generation.

As illustrated in FIG. 3, the electric power amount (Pg) from a negative SOC value to the SCL at the destination indicates the electric power generation amount required to be generated during traveling. The final soc chart is connected to the EV line from the departure point while interposing the electric power generation section between the SCH and the SCL toward the destination by reverse drawing from the value of the SCL at the destination point.

In FIG. 14, it is assumed that the state of charge of the battery at the departure point is the SCH and the target SOC at the destination point is the SCL, but these values are not required to be limited thereto, and any value between the SCL and the SCH can be used.

This planned electric power generation and storage control technology is a technology in which the SOC chart created before traveling is corrected during traveling and the SOC value at the destination can be finally reached within in an initially set range with an error. For this purpose, the position information and the vehicle information from the vehicle are sequentially obtained during traveling, and in a case where the SOC value has a deviation equal to or larger than a set value from the SOC chart, the SOC chart is recreated.

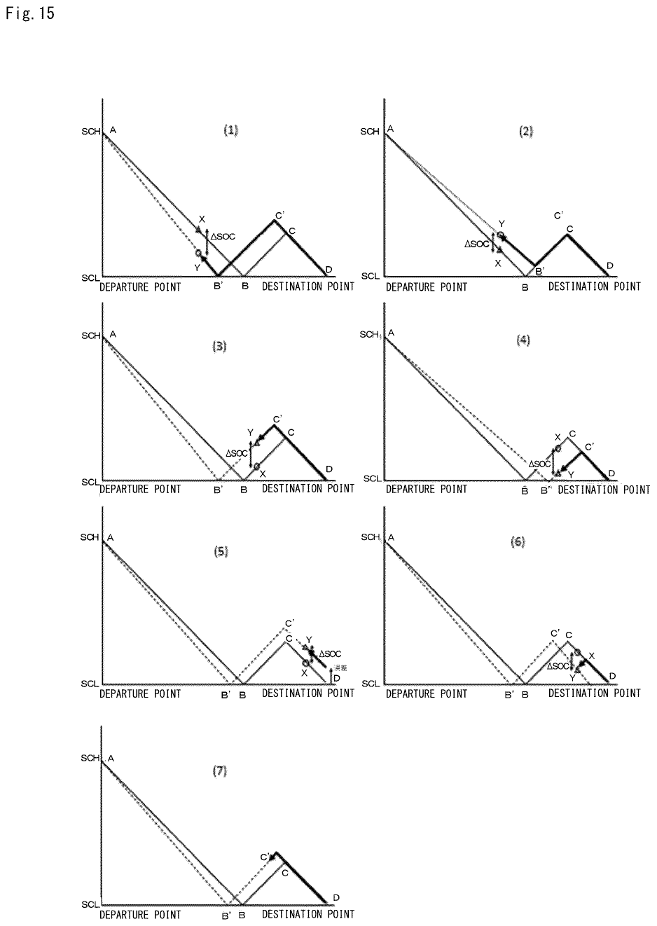

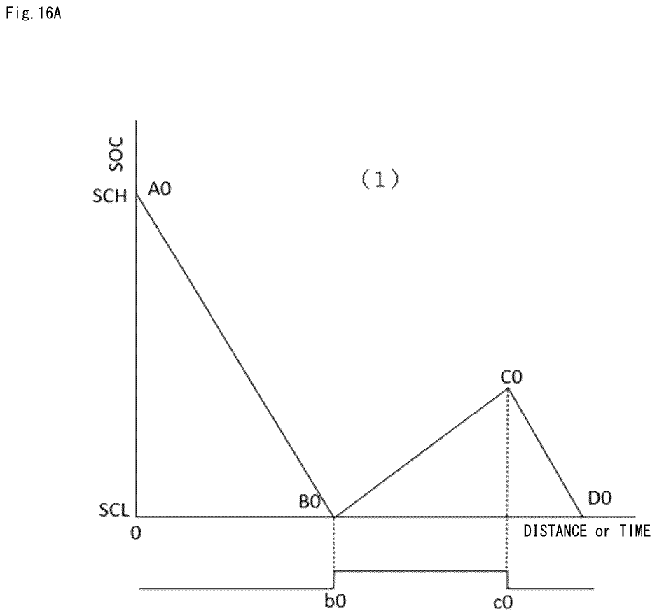

FIG. 15 illustrates a form in which the SOC chart is recreated during traveling. In FIG. 15, the SOC chart before traveling from the departure point to the destination point is represented by a solid line A-B-C-D. Further, a case where the vehicle travels in EV traveling from the departure point and SOC values as vehicle data are drawn side by side in the SOC chart is represented by a broken line. In (1), when the vehicle travels to the point Y, in a case where a state in which a deviation from X on the SOC chart drawn by the solid line is equal to or larger than a predetermined value (ΔSOC) is detected, the SOC chart is corrected from Y to D indicated by the thick solid line by reverse drawing to D-C′-B′-Y, and thus, the soc chart is recreated.

(2) to (6) also illustrate a form in which the same SOC chart is corrected and this results in recreation of the SOC chart. (3) and (4) illustrate a form in which the SOC chart is corrected in the electric power generation section between B and C. Further, (5) and (6) illustrate a form in which a deviation in the SOC occurs during EV traveling to the destination and the SOC is corrected. (5) is a result obtained by correcting the SOC in a case where a deviation in the SOC occurs at an upper portion. In this case, the SOC value at the destination point becomes a value increased by the error from the planned SCL value, but there is no problem since the electric power is stored in the battery. Further, in (6), electric power is generated in a short section Y-X during the recreation of the SOC chart.

In recreation of the SOC chart, it is desirable to suppress an increase in the number of electric power generation times as much as possible. The reason for this is that a loss due to the starting load increases at the start of electric power generation, the exhaust gas is not sufficiently reduced because it takes a time until the exhaust gas suppression device normally functions immediately after the start of electric power generation, and a failure probability increases due to an increase in mechanical stress caused by mechanically repeating ON and OFF of electric power generation.

(7) illustrates a method of reducing the deviation in the SOC at the destination that is described in (5) and a method of eliminating the short electric power generation section that is described in (6). In this case, the occurrence of the deviation in C-D such as (5) or (6) during the last EV traveling in the middle of the electric power generation B-C is detected, the electric power generation stop point is set to new C′, and the EV section is set to C′-D.

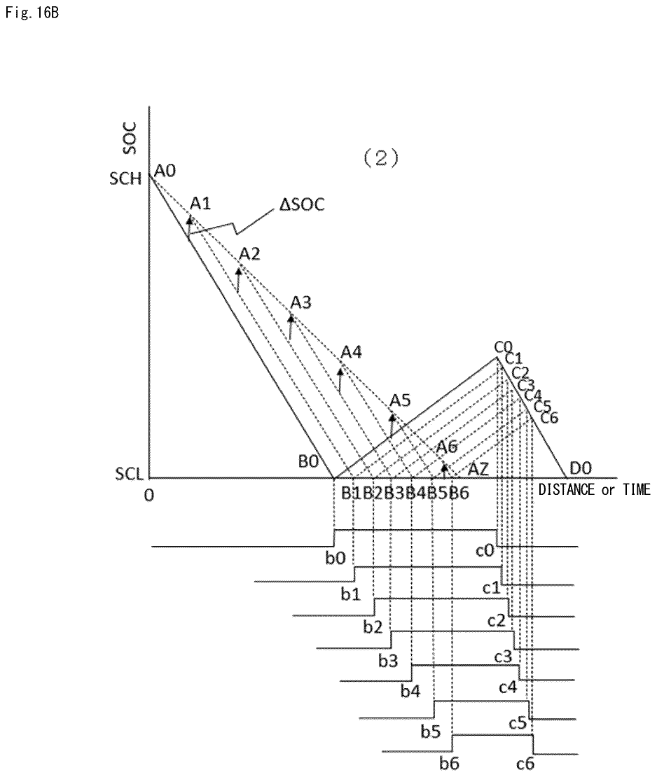

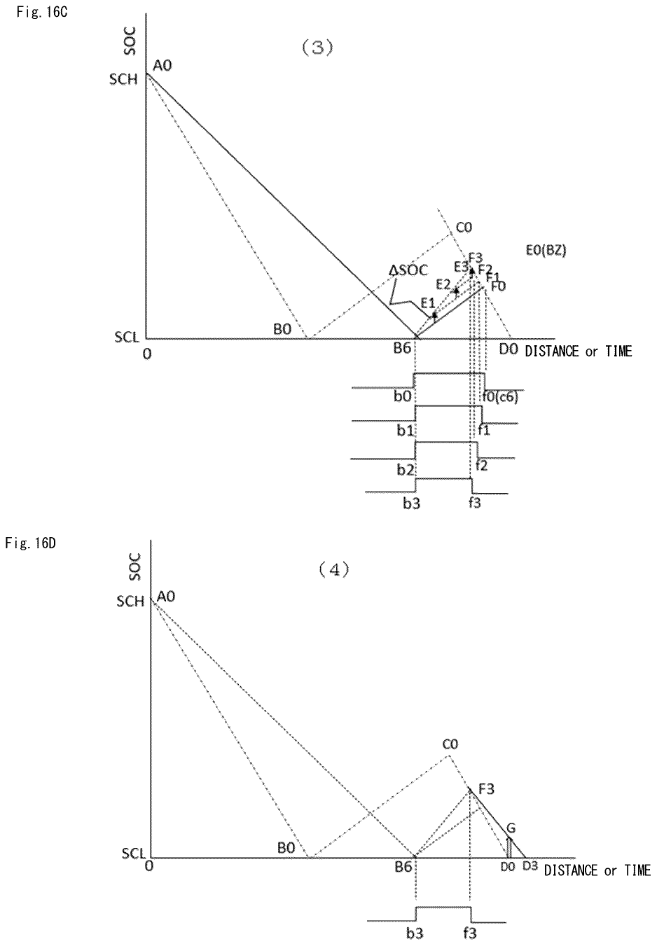

FIG. 16 relates to another method of recreating the SOC chart created before traveling. FIG. 16A illustrates an SOC chart created before traveling. In this example, A0-B0 indicates that EV traveling is performed from the SCH at the departure point to the SCL, B0-C0 indicates that traveling with electric power generation is performed, and C0-D0 to the destination point indicates that EV traveling is performed. In creating the SOC chart, among the parameters for determining the SOC chart, a value worse than the assumed value is used as the average electric power consumption, or a value faster than the assumed value is used as the average speed.

FIG. 16B illustrates a form in which A0-B0 which is the EV traveling line before traveling is corrected during traveling. A broken line A0-AZ drawn from A0 to the SCL is an SOC line drawn in a case where it is assumed that the vehicle actually travels using the average electric power consumption which can be assumed at the departure point. Since the SOC line A0-B0 before traveling uses electric power consumption (set electric power consumption) that is worse than an assumed value, the SOC line A0-B0 is always located below A0-AZ.

When the vehicle travels to A1, the deviation of the ΔSOC is detected from the A0-B0 line. Therefore, the SOC chart is recreated by reverse drawing, and thus, the soc chart becomes D0-C1-B1-A1. Further, when the vehicle travels to the point A2, the deviation of the ΔSOC is similarly detected. Therefore, the SOC chart is recreated, and thus, the SOC chart becomes D0-C2-B2-A2. Thereafter, the same correction is performed, and D0-C6-B6-A6 is closest to the SCL.

The electric power generation start point associated with the recreation of the SOC chart is shifted toward the destination point every time the correction is performed. The electric power generation start point in the SOC chart before traveling is b0, but is b1 in the first correction, and is further shifted to b2 in the second correction, and finally b6 becomes the electric power generation start point.

The electric power generation stop point expected while the EV traveling proceeds to A6 is shifted from co to c6 toward the destination point, but the electric power generation period gradually decreases. This is because the electric power consumption at the time of actual traveling is better than the set electric power consumption before traveling.

FIG. 16C illustrates a corrected state in the electric power generation section. Also in the electric power generation section, since the set electric power consumption before traveling is used to create the soc line B6-F0 to be predicted at the electric power generation start point (B6), the deviation of the ΔSOC occurs when the vehicle travels to E1, and the corrected SOC chart becomes D0-F1-E1. Further, the corrected SOC chart when the vehicle travels to E2 becomes D0-F2-E2, and the corrected SOC chart at the stop point of the electric power generation period becomes D0-F3-E3. The reason why the ΔSOC always deviates upward is that the electric power consumption during traveling takes a value better than the set electric power consumption before traveling. Therefore, the electric power generation stop point also changes from f0 (c6) to f1, f2, and f3 so as to approach the departure point, and thus, the electric power generation period also decreases.

FIG. 16D illustrates the correction of the SOC chart when EV traveling to the destination point is performed. In this example, the expected SOC chart when the vehicle travels to the point F3 becomes D0-F3, but the SOC chart when the vehicle travels to the destination point becomes D3-F3, and the SOC value at the arrival point is D0-G larger than the expected SCL. As a result, the stored electric power amount of the battery remains more than expected, but this surplus electric power amount is used for the next traveling.

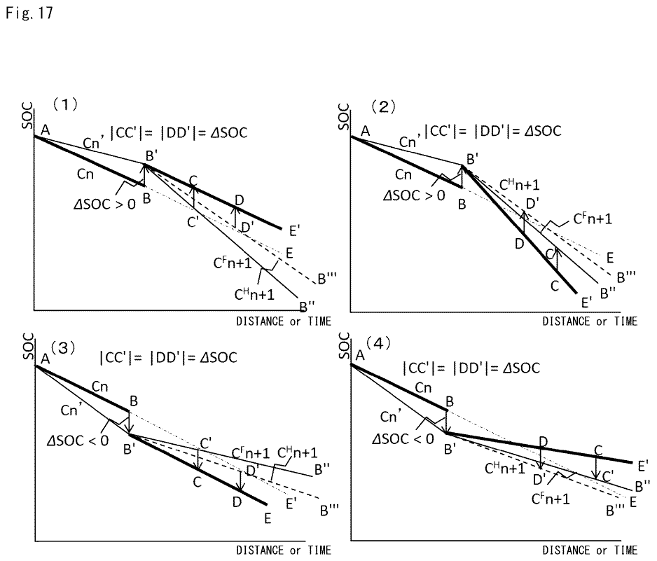

FIG. 17 illustrates an example of a creation method when recreating a specific SOC chart. Taking (1) as an example, a straight line A-E is an SOC chart at the time of planning, but is illustrated as a straight line here for simplification. A straight line A-B′ indicated by a thin solid line from A is a trajectory of the SOC value at the time of traveling, and ΔSOC is a set deviation value of the SOC. Thus, the SOC chart is recreated at the timing when ΔSOC is reached, and the recreated SOC chart becomes B′-E′. B′-B″ is a trajectory of the recreated SOC in a case where the electric power consumption obtained using the following method is used, and C′C is the same value as ΔSOC. Further, B′-B″′ indicated by a broken line is also a trajectory of the recreated SOC in a case where the electric power consumption having another value is used, and D′D is similarly equal to ΔSOC. Further, Cn is electric power consumption at the time of setting the SOC chart, Cn′ is actual electric power consumption at the time of traveling from A to B′, and C^{F}n+1 and C^{H}n+1 are electric power consumption for the next section after the value of Cn is reviewed at the point B′.

A relationship among Cn, C^{F}n+1, and C^{H}n+1 will be described below.

C^{F}n+1=Cn·(1−ΔSOC/PB)

C^{H}n+1=Cn·(1−ΔSOCs/PB)

Here, PB is the maximum electric power storage capacity [kWh] of the battery, and ΔSOCs is an arbitrary value smaller than ΔSOC having a relationship of ΔSOC>ΔSOCs. In FIG. 17, (1) and (2) illustrate a case where ΔSOC has a positive value, and the actual electric power consumption Cn′ is a value better than the electric power consumption Cn which is set before traveling. Thus, an soc trajectory (A-B′) is located above the assumed SOC chart (A-B). From the above equations, a relationship between pieces of the electric power consumption is Cn>C^{H}n+1>C^{F}n+1.

That is, the corrected SOC trajectory is B′-B″ adopting C^{F}n+1 and B′-B′″ adopting C^{H}n+1. The next SOC recreation portion is CC′ or DD′ corresponding to ΔSOC, but CC′ is in front of DD′. The adoption of C^{H}n+1 meets the purpose of reducing the number of times of recreation of the SOC as much as possible.

On the other hand, (2) illustrates a case where the traveling state changes at the point B. For example, the SOC chart (B′-E′) is recreated from B in a case where the electric power consumption deteriorates due to a steep uphill. In this case, CC′ adopting C^{F}n+1 has a recreation portion later than DD′ adopting C^{H}n+1, and thus the number of times of reproduction is reduced.

Further, (3) and (4) illustrate a case where ΔSOC has a negative value, and the actual electric power consumption Cn′ is a value worse than the electric power consumption Cn which is set before traveling. Thus, an SOC trajectory (A-B′) is located below the SOC chart (A-B) at the time of planning. A relationship among the pieces of electric power consumption C^{F}n+1, C^{H}n+1, and Cn is as follows.

C^{F}n+1=Cn·(1+|ΔSOC|/PB)

C^{H}n+1=Cn·(1+|ΔSOCs|/PB)

Here, since the ΔSOC has a negative value, the actual electric power consumption Cn′ is lower than the assumed electric power consumption Cn. From the above equations, the relationship among the pieces of electric power consumption is Cn<C^{H}n+1<C^{F}n+1.

That is, the corrected SOC trajectory becomes B′-B″ adopting C^{F}n+1, and becomes B′-B′″ adopting C^{H}n+1, and CC′ is in front of DD′. The adoption of C^{H}n+1 meets the purpose of reducing the number of times of recreation of the SOC as much as possible.

On the other hand, (4) illustrates a case where the traveling state changes at the point B. For example, the SOC chart (B′-E′) is recreated from B in a case where the electric power consumption is improved due to a steep downhill. In this case, CC′ adopting C^{F}n+1 has a recreation portion later than DD′ adopting C^{H}n+1, and thus, it can be seen that the number of times of reproduction is reduced.

Therefore, as illustrated in FIG. 17, in the recreation of the SOC, for the new electric power consumption using ΔSOC which is the set deviation value, whether a distance (time) to the next creation of the Soc chart can be increased by using C^{F}n+1, or whether it is better to use the electric power consumption C^{H}n+1 using ΔSOCs smaller than ΔSOC, depends on what kind of recreated SOC chart is created according to a state of the traveling route after the recreation.

In the present planned electric power generation and storage control method, the information on the state of the traveling route (an uphill, a downhill, a highway, a traffic jam condition, a change in loading weight of cargo, or the like) is updated in advance or sequentially. Thus, it is possible to adjust the electric power consumption after the recreation on the basis of the information. For example, in a case where improvement in the electric power consumption is expected by lowering a cargo loaded from a work place during traveling, it is possible to automatically change the electric power consumption to reflect the weight difference. In addition, in a case where an auxiliary device such as an air conditioner is used during traveling, it is possible to change the electric power consumption in consideration of the electric power amount used for this case.

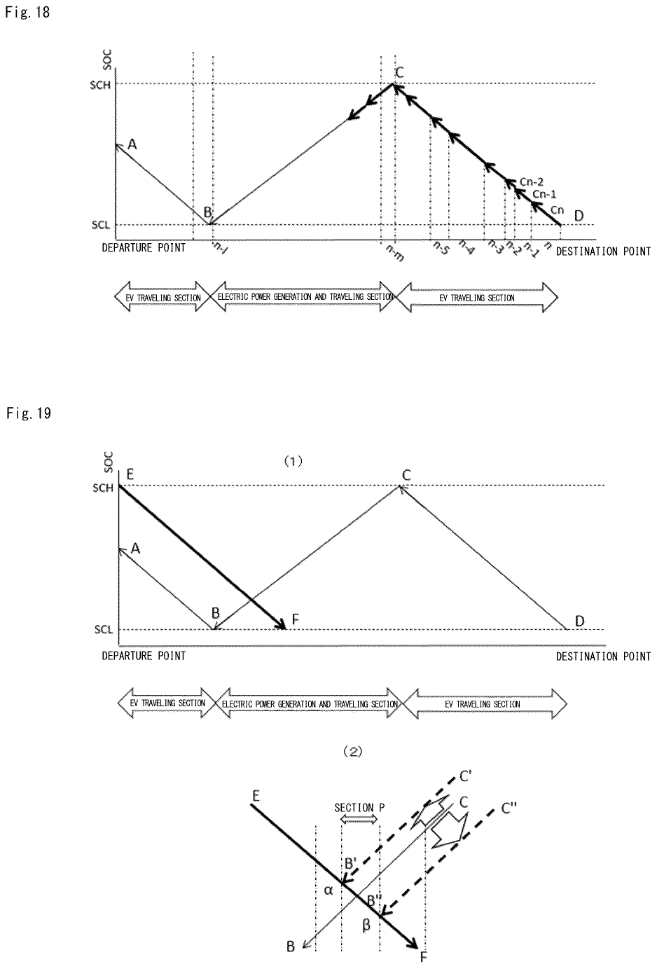

FIG. 18 relates to the creation of the SOC chart before traveling, and illustrates a case where the SOC chart is configured by a large number of short distance sections (n, n−1, n−2, and the like) from the departure point to the destination point when it is assumed that the SOC chart is created by reverse drawing and the horizontal axis of the graph indicates a distance. There are various ways of defining the sections, and for example, it is considered to set, as one section, the traveling route on which the state of the traveling route (an uphill, a downhill, a flat road, or the like) continues. However, it is practically difficult to define division of a hill from a flat road. In this example, a distance in which the center line of the traveling route is defined as a straight line is set as one section. For example, in a case where a width deviates from the center line by ±30 cm, it is determined that the straight line is ended.

The SOC chart is created from the destination point (D) toward the departure point (A), but a length of each distance section is not uniform. In FIG. 18, the length of the arrow is proportional to the length of each distance section, and the SOC returning from D by one section is Cn, which is longer than Cn−1 of the SOC of the next section in terms of distance, and Cn−2 of the SOC of the previous section is shorter than Cn−1. At this time, assuming that the SOC value at the entrance of each section is B_SOC, the electric power consumption amount which is consumed at the section is C_SOC, and the electric power generation amount when electric power generation is performed at the section is G_SOC, the following relationship is established. Note that the entrance represents the start of the arrow and the exit represents the end of the arrow, and each SOC is expressed as %.

B_SOCn=B_SOCn−1−C_SOCn+G_SOCn

That is, B_SOCn at the destination point is obtained by considering the electric power consumption amount C_SOCn and the electric power generation amount G_SOCn at the section Cn, into B_SOCn−1 at the entrance of the previous section Cn−1. Of course, in this example, since the Cn section is the EV traveling section, G_SOCn is 0.

In this manner, the SOC chart is created by reverse drawing from the destination point toward the departure point, and in a case where the chart in EV traveling reaches the SCH at C, the vehicle is switched to traveling with electric power generation (C-B) at the entrance or the exit of the section (n-m) including the point. Then, in a case where the SOC reaches the SCL at the point B, the vehicle is switched to EV traveling (B-A) at the entrance or the exit of the section (n-l) including the point B. However, in a case where it is assumed that the SOC value always exists within the range between the SCL and the SCH, the state is switched at the entrances of the section (n-m) at the point C and the section (n−1) at the point B. In this way, the state can be switched within the range between the SCL and the SCH.

Next, as illustrated in (1) of FIG. 19, after the SOC chart is created as D-C-B-A by reverse drawing, the Soc chart is created in the forward direction in EV traveling from the SOC set value (SCH in this example) at the departure point, but the SOC chart intersects with the previously-created SOC chart C-B in the middle of the traveling route. (2) illustrates a method of adjusting the SOC chart when the SOC charts intersect with each other, and in a case where both the SOC charts intersect with each other in the section P, the electric power generation line B-C is shifted to either the entrance 3 or the exit a of the section. FIG. 19 illustrates a case where the electric power generation line C-B is translated upward so as to intersect at a to be C′-B′ and a case where the electric power generation line C-B is translated downward so as to intersect at 3 to be C″-B″. However, in a case where the electric power generation line is shifted downward, there is a possibility that the SOC value is equal to or lower than the SCL. Therefore, it is more appropriate to shift the electric power generation line upward. In a case where the electric power generation line is shifted upward, there is a possibility that a point at which C′ is extended becomes higher than the SCH. However, since the battery has a certain allowable range for overcharging, there is no problem.

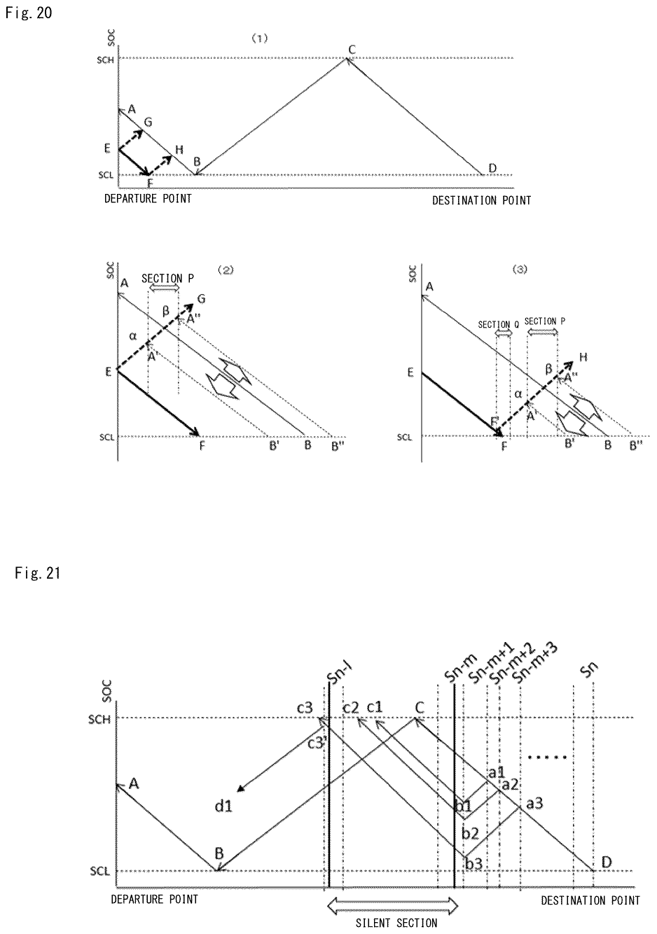

(1) of FIG. 20 illustrates an adjustment method in a case where, although the SOC chart is created up to the departure point as in D-C-B-A by reverse drawing, the electric power storage amount of the battery at the departure point is smaller than the SOC value A at the departure point on the line drawn by reverse drawing. In this case, two methods are considered, one is a method of performing traveling with electric power generation E-G at the departure point and making the traveling line intersect with the EV traveling line B-A, and the other is a method of first performing EV traveling E-F, performing switching to traveling with electric power generation F-H when the SOC value reaches the SCL, and making the traveling line intersect with the EV traveling line B-A.

(2) illustrates the former method, and indicates whether the line B-A drawn by reverse drawing is shifted to the lower line B′-A′ or the upper line B″-A′′. In this case, a width of the shift is determined by the section P. In a case of shifting to the lower side, intersection occurs at a, and in a case of shifting to the upper side, intersection occurs at B.

(3) illustrates a case of performing EV traveling E-F first, performing switching to the traveling line F-H with electric power generation when the SOC value reaches the SCL, and making the line B-A drawn by reverse drawing shift to the upper side or the lower side. In order to perform switching from the EV traveling line (E-F) to the electric power generation line, switching is performed from the exit F′ of the section Q including the point (F) at which the SOC value reaches the SCL. At the exit of the section P including the point at which the electric power generation line (F′-H) and the EV line drawn by reverse drawing intersect with each other, since the lines intersect with each other at α, the line drawn by reverse drawing is shifted to the lower side and thus becomes the line B′-A′. In a case where the line drawn by reverse drawing is shifted to the upper side, since the lines intersect with each other at β, the line drawn by reverse drawing becomes the line B″-A′′.

FIG. 21 illustrates a method of creating an SOC chart when there is a silent section on the traveling route. When the SOC line (D-C) is drawn by reverse drawing from the destination point D, a point C at which the SOC value reaches the SCH and switching to the traveling line with electric power generation should be performed is within a section of the silent section. Therefore, in a case where switching to the traveling line with electric power generation is performed at the entrance al of one section (Sn-m+1), which is included in the section (Sn-m) including the exit of the silent section and is closer to the destination, and switching back to the EV traveling line is performed at the entrance b1 of the section (Sn-m), the SOC value reaches the SCH at the point c1, but the point is still within the silent section. Therefore, even in a case where switching from the EV traveling line to the electric power generation line is performed at the entrance a2 of the section (Sn-m+2) and switching back to the EV line is performed at the entrance b2 of the section (Sn-m), the point c2 at which the SOC value reaches the SCH is within the silent section. Here, in a case where switching from the EV traveling line to the electric power generation line is performed at the entrance a3 of the section (Sn-m+3) and switching back to the EV line is performed at the entrance b3 of the section (Sn-m), the point c3 at which the SOC value reaches the SCH is outside the silent section. Therefore, by performing switching to the traveling line (c3′-d1) with electric power generation at the exit point C3′ of the distance section (Sn-l) including the entrance point of the silent section, it is possible to create an SOC chart (D-a3-b3-c3′-d1) that enables EV traveling in the silent section by reverse drawing.

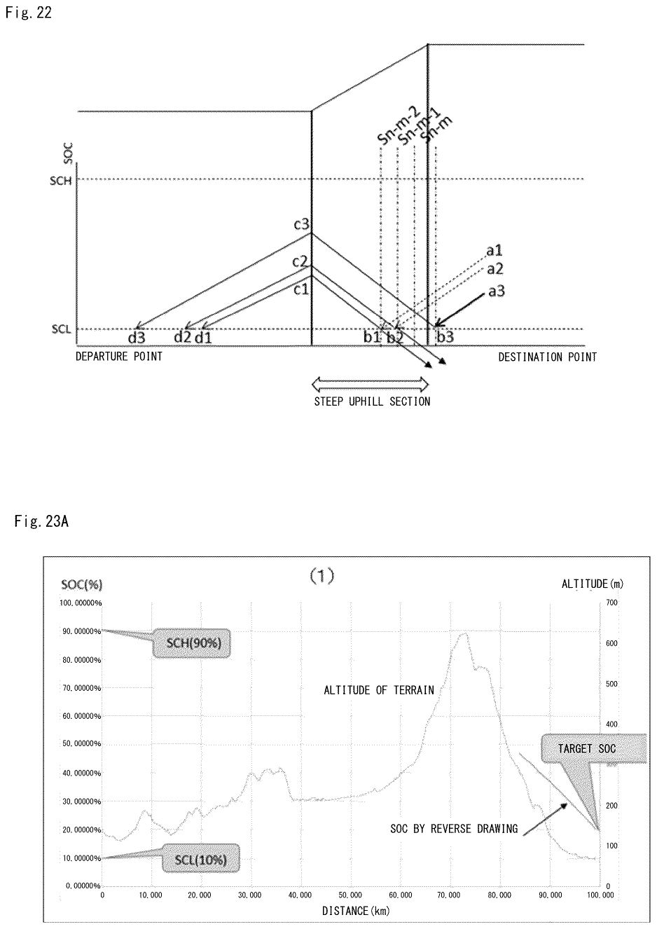

FIG. 22 illustrates a case where there is a steep uphill on which the battery cannot be charged even when electric power generation is performed in the middle of the traveling route. Therefore, the SOC value indicating the state of charge of the battery decreases even in the electric power generation state. For example, even in a case where the SOC chart is created as a1-b1-c1-d1, the Soc decreases due to a steep uphill and reaches the SCL at the exit b1 of the section (Sn-m−2). As a result, an electric power shortage occurs. Therefore, even in a case where the SOC chart is shifted to the exit b2 of the previous section (Sn-m−1), an electric power shortage still occurs at b2. As a result, in a case where the SOC chart is shifted to the entrance b3 of the section (Sn-m) of which the section distance includes the exit point of the uphill, the vehicle can travel without an electric power shortage. The SOC chart in this case becomes a3-b3-c3-d3, and it can be seen that, by making the electric power generation start point earlier from d1 to d3, the vehicle can travel on a steep uphill.

Note that the horizontal axis in FIG. 16 to FIG. 20 is expressed as a distance, but of course, a similar mechanism is considered even for time, and in this case, the distance of each section is replaced with a unit time (for example, one second).

Although the PRE-EV vehicle in which the generator is mounted has been described so far, the planned electric power generation and storage technology can also be applied to a so-called EV vehicle that travels only with a battery. Many vehicles are provided with a navigation system, and a driver sets a destination to obtain various useful information unique to an EV. For example, a charger installation place or the like on a traveling route to the destination is displayed on a display. On the other hand, map information of most navigation systems is only position information related to latitude and longitude, and altitude information cannot be obtained. In addition, even in a case where altitude is displayed, for example, in a tunnel, altitude of a tunnel-like terrain can be obtained. However, since the electric power consumption greatly changes on an uphill, a downhill, or the like, an EV vehicle that uses only the electric power storage amount of the battery as an electric power source is greatly influenced by a change in altitude. The present planned electric power generation and storage control technology is also effective for EV vehicles by also incorporating altitude information of a traveling route itself to create a traveling plan (SOC chart creation) even in a case where, as in a tunnel, the altitude of the traveling route is different from the altitude of the terrain. The following application is considered.

By incorporating traveling route information to a destination before traveling and recognizing in advance the influence of the uphill and the downhill of the traveling route on the electric power consumption, efficient and comfortable traveling can be performed. Specifically, in a case where there is a long downhill and regenerative electric power corresponding to the downhill is expected, charging of the battery before traveling is suppressed such that the SOC value is equal to or lower than the SCH. Thus, the electric power amount can be reduced and the charging time can be shortened. In addition, by monitoring the SOC from the change in electric power consumption according to the state of the traveling route, in a case where an electric power shortage may occur, it is possible to prevent an electric power shortage by accurately predicting the charger installation position and the arrival timing and urging charging. Further, by constantly monitoring the SOC during traveling, the predicted values of the SOC are sequentially displayed at points on the traveling route after the current point as appropriate, and thus, the driver can recognize a more accurate vehicle state.

In addition, in a commercial vehicle, in a case where a plurality of EV cars are charged by a limited charger for the next day charging, it is possible to control the charging order and the charging amount of each vehicle, and thus, it is also possible to contribute to improvement in operation efficiency.

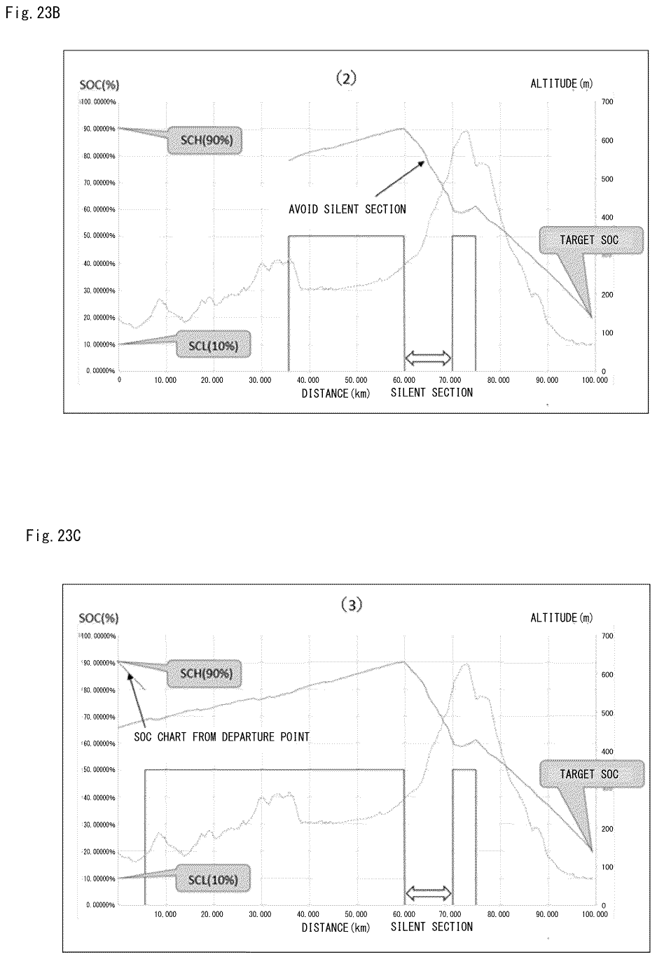

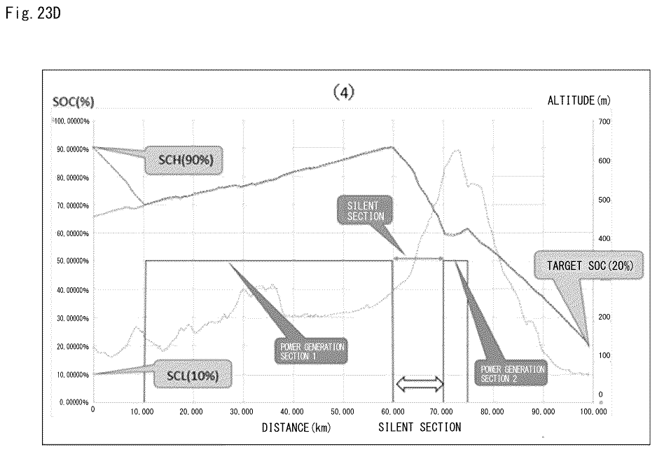

(1) to (4) of FIG. 23 illustrate a process of creating an SOC chart according to this algorithm, the SOC chart being drawn using EXCEL (registered trademark of Microsoft Corporation) for program verification. horizontal axis represents a distance, and a vertical axis represents a state of charge of the battery mounted on the vehicle by SOC. In FIG. 23, an undulation indicates altitude of the terrain. In FIG. 23, traveling of approximately 100 km is assumed. The SOC value of the battery before traveling is set to 90%, and is set to 20% at the destination.

(1) illustrates a form in which creation of the soc chart is started by reverse drawing in a case where the SOC value at the destination is 20%. (2) illustrates a form in which, since there is a silent section such as a tunnel in the middle of the traveling route, an electric power generation section is provided while avoiding the silent section. In addition, it can be seen that the chart is created using an electric power generation section after the SOC value reaches the SCH (90%). (3) illustrates a form in which the chart is drawn to the departure point by reverse drawing and then the SOC chart is redrawn from the SCH (90%). (4) is a diagram in which creation of the SOC chart is completed, and illustrates a form in which the SOC chart is not linear but changes to reflect a change in the electric power consumption of the vehicle due to a change of the terrain.

The method for traveling to the destination has been described so far in which the traveling route to the destination is known in advance, the SOC chart is created by calculating the electric power consumption amount required for traveling from the departure to the destination, the actual SOC value is constantly monitored during traveling, and the SOC chart is recreated in a case where the deviation value from the SOC value created before traveling becomes equal to or higher than the set value. Therefore, in a case where there is a route change during traveling, for example, in a case where a steep uphill appears, in order to charge the battery in some cases, it is required to take measures such as reducing the speed or stopping to charge the battery. However, by taking the following measures, traveling can be performed without causing an electric power shortage.

First, what kind of situation may occur in a case where there is a route change during traveling will be described.
1. A case where there is an uphill on the traveling route after the route change and the SOC increases when electric power is stored by a generator in ascending the uphill.
2. A case where there is an uphill on the traveling route after the route change, the SOC decreases even though electric power is stored by a generator when ascending the uphill, and the vehicle does not reach the top of the uphill even though the vehicle travels.
3. A case where there is a silent section on the traveling route after the route change, and the SOC reaches the lower limit value before the vehicle exits the silent section.
4. A case where there is a long downhill on the traveling route after the route change, regenerative electric power is accumulated, and thus, the SOC value reaches the upper limit in the middle of the hill.

The following measures are considered for these cases.
1. No action required.
2. The lower limit value (SCL) of the state of charge of the battery before the hill is set to the electric power amount equal to a value which is obtained by subtracting the electric power amount that can be stored by electric power generation from the electric power amount required for ascending the hill.
3. The lower limit value (SCL) of the state of charge of the battery before the silent section is set to the electric power amount to exit the silent section, and traveling is performed.
4. The upper limit value (SCH) of the state of charge of the battery before the hill is set to a value obtained by subtracting, from the maximum value of the soc, the regenerative electric power amount obtained from the downhill.

A specific example will be described with reference to the measure 2. For example, the vehicle travels while calculating a difference Ah between the highest elevation of all side roads on which the route change may occur, including the traveling route scheduled to 20 km ahead, and the elevation at the current point. In a case where the electric power amount obtained by converting the position energy (m·g·Δh) of the elevation difference Δh is set as ΔSOC and the current state of charge is set as an Soc value, control is performed such that the SOC value is always equal to SOC+ΔSOC during traveling. Thus, for example, even in a case where there is an unexpected route change, there is no disruption to traveling. Then, after passing the side road with the highest elevation, the elevation of the side road with the next highest elevation is recognized again as the highest elevation, and the vehicle continues traveling while performing the same operation. In this way, it is possible to consider the elevations of the entire traveling route ahead, including all side roads, and thus, it is possible to perform traveling without creating an SOC chart at the departure place. Further, according to this means, the present invention can be applied not only to trucks for which the traveling route is often determined but also to other vehicles (for example, passenger cars) for which the traveling route is frequently changed.

For example, in a case where a vehicle has been traveling on the Tomei expressway between Odawara and Numazu, but the road has been closed due to an unexpected accident and it is required to cross Mount Hakone on National Route 1, the vehicle needs to ascend a hill of Mount Hakone having a height of approximately 800 m. In a case where an 8-ton truck is traveling, 17.6 kWh, which is an electric power amount equivalent to potential energy corresponding to 800 m, corresponds to ΔSOC. In a case where the capacity of the battery is 40 kWh, 17.6 kWh is 44% of the total SOC. In a case where the SCL is set to 20%, the vehicle travels while maintaining the remaining electric power of the battery to 64%.

Further, in a case where the traveling distance on that day is approximately 100 km, it is also possible to calculate ΔSOC by extracting the highest elevation from the elevations of all the side roads using elevation data of all traveling routes and side roads on which the vehicle may travel. Even in this case, it is not required to create an SOC chart before traveling.

### Industrial Applicability

The planned electric power generation and storage control technology according to the present invention relates to a traveling system of a PRE-EV vehicle that performs traveling by storing electric power in a battery using an engine generator and driving a motor using the stored electric power. The traveling system according to the technology estimates, before traveling, an electric power generation amount required for traveling, and corrects the electric power generation amount during traveling. Thus, more efficient traveling can be performed, and as a result, it is possible to realize a vehicle using a smaller battery and a smaller motor as compared with a vehicle in the related art. Thereby, without reducing the number of seats and the loading amount of a commercial vehicle, the use efficiency of the engine for electric power generation can be improved. Therefore, according to the technology, it is possible to reduce fuel consumption and suppress CO₂ emission associated with fuel consumption.

Further, examples of an application field of the present technology include a mobile electric power storage device for disasters. In a case of a sudden natural or human disaster, the electric power supply means may be damaged by the disaster, and the electric power supply in the disaster area may be disrupted. In that case, it is required to dispatch a mobile power supply vehicle to the site, but there may be a disadvantage that it takes time. However, even in a case where a commercial vehicle using the present technology is normally traveling for delivery work or the like, when a disaster occurs in the vicinity, it is possible to immediately dispatch the commercial vehicle, and thus, the commercial vehicle can supply electricity as a power supply vehicle. In that case, the vehicle performs traveling to the site at high speed while performing forced electric power generation such that full charging is achieved at the site.

1. A planned electric power generation and storage control technology using an SOC chart for a PRE-EV vehicle that performs traveling using a mounted battery by charging the battery of the vehicle using an engine generator and driving a motor using electric power of the battery, the technology comprising: a means for obtaining an electric power generation amount required for traveling on a traveling route when creating the SOC chart using traveling route information before traveling.

2. A planned electric power generation and storage control device using an SOC chart for a range extended EV that performs traveling using a mounted battery by charging the battery of the vehicle using an engine generator and driving a motor using electric power of the battery, the device comprising:
an SOC chart creation means for creating an SOC chart required for traveling on a traveling route, which is set by traveling route information, by using the traveling route information, and a speed, electric power consumption, and a weight which are given as provisional values before traveling.

3. The planned electric power generation and storage control device using the SOC chart according to claim 2, further comprising:
an SOC chart correction means for correcting the SOC chart on the basis of a speed, electric power consumption, or a weight that can be acquired at the time of traveling.

4. The planned electric power generation and storage control device using the SOC chart according to claim 3, wherein the SOC chart correction means includes a monitoring means for monitoring a deviation value, which is a difference from an SOC value from the SOC chart planned before traveling by using position information at a traveling point that is obtained from a position information collection device such as a GPS during traveling of the vehicle, vehicle information such as an SOC value representing a state of charge of the battery from the vehicle, and map information, and a recreation means for sequentially recreating the SOC chart during traveling in a case where the deviation value reaches a set value.

5. The planned electric power generation and storage control device using the SOC chart according to claim 2, further comprising: a prediction means for predicting that the vehicle cannot reach a destination due to an unexpected situation during traveling even in a case where the SOC chart correction means corrects the SOC chart; and an instruction means for giving a driving instruction adapted to the situation to a driver of the range extended EV.

6. The planned electric power generation and storage control device using the SOC chart according to claim 2, wherein the SOC chart creation means assumes that the vehicle travels to a destination using a state of charge of the battery at a departure point in order to obtain a required electric power generation amount, and sets an absolute value of a value obtained by adding a required minimum electric power storage amount (SCL) of the battery to a negative electric power amount obtained from an SOC value at a destination point, as an electric power generation amount required for traveling.

7. The planned electric power generation and storage control device according to claim 6, wherein the SOC chart creation means creates an SOC chart by drawing an EV line according to traveling using the battery, the EV line representing a state of charge of the battery in traveling using the battery and being drawn by reverse drawing from a set SOC value at the destination point toward a departure point, repeating a process of performing switching to an electric power generation line in a case where an SOC value reaches a maximum electric power storage amount (SCH) or a set SOC value and then performing switching back to the EV line for traveling using the electric power storage amount of the battery in a case where an SOC value reaches a required minimum electric power storage amount (SCL) or a set SOC value, and setting a point at which the EV line for traveling using the battery from a departure point intersects with the electric power generation line drawn by reverse drawing, as a point at which the EV line for traveling using the battery is stopped and the electric power generation line is started.

8. The planned electric power generation and storage control device according to claim 7, wherein the SOC chart creation means is configured to create an SOC chart by: in a case where an SOC value may be equal to or lower than a required minimum electric power storage amount (SCL) during traveling, performing electric power generation for obtaining an electric power generation amount at which an SOC value is not equal to or lower than the SCL on a traveling route closer to a departure point than a traveling point; in a case where an SOC value is equal to or higher than a maximum electric power storage amount (SCH), further stopping electric power storage to an extent equivalent to the electric power generation amount exceeding the SCH on the traveling route closer to the departure point than the traveling point; in a case where an engine has to be driven in a silent section, further avoiding electric power generation driving in the silent section by generating, before the vehicle enters the silent section, an electric power amount required for traveling using the battery in the silent section; and setting an electric power generation period and an electric power generation section such that the SOC chart falls within a range from the SCL to the SCH in traveling from a departure place to the destination.

9. The planned electric power generation and storage control device using the SOC chart according to claim 2, wherein the SOC chart creation means determines whether or not to perform charging using a charger in a case where an installation place of the charger is known in advance on a traveling route on which traveling using the battery is performed, and reflects a result of the determination in the SOC chart created before traveling.

10. A range extended EV that performs traveling using a mounted battery by charging the battery of the vehicle using an engine generator and driving a motor using electric power of the battery, the range extended EV comprising:
a control device that is for charging the battery of the vehicle by the engine generator, the control device using the planned electric power generation and storage control device according to claim 2.

11. A planned electric power generation and storage control method using an SOC chart for a range extended EV that performs traveling using a mounted battery by charging the battery of the vehicle using an engine generator and driving a motor using electric power of the battery, the method comprising:
an SOC chart creation step of creating an SOC chart required for traveling on a traveling route, which is set by traveling route information, by using the traveling route information, and a speed, electric power consumption, and a weight which are given as provisional values before traveling; and
an SOC chart correction step of correcting the SOC chart on the basis of a speed, electric power consumption, or a weight that can be acquired at the time of traveling.
